(19) United States
(12) Patent Application Publication
(10) Pub. No.: US 2012/0140158 A1
(43) Pub. Date: Jun. 7, 2012

(54) LIQUID CRYSTAL DISPLAY DEVICE AND METHOD FOR MANUFACTURING LIQUID CRYSTAL DISPLAY DEVICE

(75) Inventors: Hijiri Nakahara, Osaka (JP); Yukinobu Nakata, Osaka (JP); Takaharu Yamada, Osaka (JP); Seiji Muraoka, Osaka (JP)

(73) Assignee: SHARP KABUSHIKI KAISHA, Osaka (JP)

(21) Appl. No.: 13/390,386

(22) PCT Filed: Jun. 25, 2010
(86) PCT No.: PCT/JP2010/060880

§ 371 Date: Feb. 14, 2012

(30) Foreign Application Priority Data
Aug. 21, 2009 (JP) 2009-192356

(51) Int. Cl. G02F 1/1343; H01J 9/24

(52) U.S. Cl. 349/139; 445/24

(57) ABSTRACT

A pad section 112 of a liquid crystal display device and a main surface of a substrate located in a periphery of the pad section 112 are formed so as to be exposed from a multilayer film 109. The pad section 112 is formed of an aluminum alloy material film, and the difference between a potential of the aluminum alloy material film and that of an ITO film is smaller than the difference between a potential of an aluminum film and that of the ITO film.

### TECHNICAL FIELD

The present invention relates to a liquid crystal display device and to a method of manufacturing a liquid crystal display device.

### BACKGROUND ART

There have been suggested various types of liquid crystal display devices. For example, a liquid crystal display device described in Japanese Patent Application Laid-Open Publication No. H9-197433 (Patent Document 1) has a transparent substrate, a gate electrode, a gate pad, a source electrode, and a drain electrode, which are formed on the substrate.

In the periphery of the gate pad, an insulating film is formed. In addition, an ITO film is formed on the upper surface of the gate pad as well as the insulating film located in the periphery of the gate pad.

### RELATED ART DOCUMENTS

### Patent Documents

Patent Document 1: Japanese Patent Application Laid-Open Publication No. H9-179433

### SUMMARY OF THE INVENTION

### Problems to be Solved by the Invention

However, in the above-mentioned conventional liquid crystal display device, there is a risk of the ITO film disconnecting because of a step formed between the upper surface of the insulating film located in the periphery of the gate pad and the gate pad.

The present invention seeks to address the problem described above, and has an object to provide a liquid crystal display device in which disconnection of an ITO film is suppressed and a method of manufacturing the liquid crystal display device.

### Means for Solving the Problems

A liquid crystal display device according to the present invention has the following: a substrate having a pixel arrangement region and a peripheral region that is located in a periphery of the pixel arrangement region; a switching element formed in the pixel arrangement region; an electrode provided in the switching element; a lead-out wire connected to the switching element; a pad section connected to the lead-out wire; a transparent conductive film formed on pad sections; and a multilayer film that is formed in the pixel arrangement region and that is formed of a plurality of laminated films. The pad sections and a main surface of the substrate located in the periphery of the pad sections are formed so as to be exposed from the multilayer film, and the pad section are formed of an aluminum alloy material film. The difference between a potential of the aluminum alloy material film and that of the transparent conductive film is smaller than the difference between a potential of an aluminum film and that of the transparent conductive film.

Preferably, the transparent conductive film is formed to reach a peripheral surface of and an upper surface of the pad section from a main surface of the substrate that is located in the periphery of the pad section.

Preferably, the multilayer film is formed in the pixel arrangement region, and is formed so as to expose the lead-out wire located in the peripheral region.

Preferably, the transparent conductive film is formed on a portion of the lead-out wire that is exposed from the multilayer film. Preferably, the transparent conductive film is formed only on the upper surface of the pad section.

Preferably, conductive deposits are formed in the aluminum alloy material film, and the deposits are formed so as to be exposed from the upper surface and the peripheral surface of the pad section.

Preferably, the lead-out wire is formed of the aluminum alloy material film, and a portion of the lead-out wire located in the peripheral region is formed so as to be exposed from the multilayer film. Conductive deposits are formed in the aluminum alloy material film forming the pad section and the lead-out wire, and the deposits are formed so as to be exposed from a portion of the surface of the lead-out wire exposed from the multilayer film and a surface of the pad section. The transparent conductive film is formed on portions of the lead-out wire exposed from the multilayer film and on the pad section.

Preferably, a plurality of switching elements are formed in the pixel arrangement region. The switching elements include a first switching element and a second switching element, and the lead-out wire includes a first lead-out wire connected to the first switching element and a second lead-out wire connected to the second switching element. The pad section includes a first pad section connected to the first lead-out wire and a second pad section connected to the second lead-out wire, and the first pad section is formed so as to be farther away from the pixel arrangement region than the second pad section.

Preferably, a plurality of switching elements are formed in the pixel arrangement region, and the switching elements include a first switching element and a second switching element. The lead-out wire includes a first lead-out wire connected to the first switching element and a second lead-out wire connected to the second switching element, and the pad section includes a first pad section connected to the first lead-out wire and a second pad section connected to the second lead-out wire. The first pad section is formed so as to be farther away from the pixel arrangement region than the second pad section, and the first lead-out wire is covered by an insulating film.

Preferably, a gate insulating film formed on the main surface of the substrate so as to cover the gate electrode, a semiconductor layer formed on the gate insulating film, a source electrode and a drain electrode formed on the semiconductor layer, and an interlayer insulating film formed so as to cover the source electrode and the drain electrode are further provided. The multilayer film includes at least the interlayer insulating film.

Preferably, the aluminum alloy material film contains aluminum as a base material, an alloy component containing at least one type of element selected from a group constituted of cobalt, rhodium, nickel, palladium, carbon, silicon, germanium, and tin, and another component containing an element that is different from aluminum and the elements listed. The sum of the elements in the alloy component and the elements in another component is set to be three types of elements or more.

Preferably, the aluminum alloy material film has aluminum as a base material, an alloy component containing at least one type of element selected from a group constituted of cobalt (Co), rhodium (Rh), nickel (Ni), palladium (Pd), carbon (C), silicon (Si), germanium (Ge), and tin (Sn), and another component containing at least one type of element selected from a group constituted of copper (Cu), lanthanum (La), boron (B), neodymium (Nd), silver (Ag), gold (Au), platinum (Pt), yttrium (Y), niobium (Nb), tungsten (W), and zirconium (Zr). Preferably, the aluminum alloy material film contains 0.5 wt % or more of the alloy component.

Preferably, the alloy component contained in the aluminum alloy material film is 4.5 wt % or less.

Preferably, the switching element includes a gate electrode formed on the main surface of the substrate, a semiconductor layer formed on the gate electrode, a source electrode formed on the semiconductor layer, and a drain electrode that is formed on the semiconductor layer and that is formed so as to have a distance from the source electrode. The lead-out wire includes a gate line connected to the gate electrode and a gate line connected to the source electrode. The pad section includes a gate pad connected to the gate line and a source pad connected to the source line. The gate electrode, the gate line, and the gate pad are formed of the aluminum alloy material film.

Preferably, the source electrode and the drain electrode include the aluminum alloy material film.

A method of manufacturing a liquid crystal display device according to the present invention includes the following: preparing a substrate having a main surface; forming an aluminum alloy material film on the main surface of the substrate; patterning the aluminum alloy material film to form a pad section; forming a multilayer film as to expose the pad section and the main surface of the substrate located in the periphery of the pad section, the multilayer film including a plurality of laminated films; and forming a transparent conductive film for pad sections on the pad section. The difference between a potential of the aluminum alloy material film and that of the transparent conductive films for pad sections is smaller than the difference between a potential of an aluminum film and that of the transparent conductive films for the pad section.

Preferably, forming the transparent conductive films for pad sections on the pad section includes forming a transparent conductive film on the pad section exposed from the multilayer film and patterning the transparent conductive film such that the transparent conductive film remains on an upper surface and a peripheral surface of the pad section.

Preferably, forming the transparent conductive film for pad sections on the pad section includes forming a transparent conductive film on the main surface of the substrate and on the pad section that are exposed from the multilayer film and patterning the transparent conductive film such that the transparent conductive film reaches a peripheral surface and an upper surface of the pad section from the main surface of the substrate located in the periphery of the pad sections.

Preferably, the aluminum alloy material film is patterned to form the pad section, a gate electrode located on the main surface of the substrate, and a lead-out wire connecting the pad section to the gate electrode. Forming the multilayer film includes forming a gate insulating film that covers the gate electrode and the lead-out wire, and forming the transparent conductive film for pad sections on the pad section includes patterning the transparent conductive film such that the transparent conductive film for pad sections remains on the pad section that are exposed from the gate insulating film.

Preferably, forming a conductive deposit in the aluminum alloy material film and exposing the deposit from a surface of the pad section are further included.

Preferably, the aluminum alloy material film is patterned to form the pad section, a gate electrode located on the main surface of the substrate, and a lead-out wire connecting the pad section to the gate electrode. Forming the multilayer film includes forming a gate insulating film that covers the pad section, the gate electrode, and the lead-out wire, and the deposit is formed by heat generated when the gate insulating film is formed.

### EFFECTS OF THE INVENTION

According to a liquid crystal display device and a method for manufacturing a liquid crystal display device according to the present invention, disconnection of the ITO film can be suppressed.

### BRIEF DESCRIPTION OF THE DRAWINGS

FIG. 1 is an exploded perspective view showing a configuration of a television receiver 500 according to Embodiment 1 of the present invention.

FIG. 2 is a perspective view schematically showing a liquid crystal display device 300.

FIG. 3 is a plan view schematically showing a liquid crystal display element 200.

FIG. 4 is an exploded perspective view showing an arrangement state of a liquid crystal display panel 101 and polarizing plates 156.

FIG. 5 is a plan view of the liquid crystal display panel 101.

FIG. 6 is a circuit diagram showing a thin film transistor array formed on an active matrix substrate 130.

FIG. 7 is a cross-sectional view of the active matrix substrate 130.

FIG. 8 is a plan view of a peripheral region 105.

FIG. 9 is a cross-sectional view along the line IX-IX in FIG. 8.

FIG. 10 is a cross-sectional view along the line X-X in FIG. 8.

FIG. 11 is a cross-sectional view schematically showing a site of contact between an aluminum alloy material film 136b and a pixel electrode 116.

FIG. 12 is a cross-sectional view showing a gate pad 112 in detail.

FIG. 13 is a cross-sectional view showing a first process step of process steps of the liquid crystal display device 300.

FIG. 14 is a plan view of a region where gate pads 112A and 112B are formed in the first process step of the process steps of the liquid crystal display device 300 shown in FIG. 13.

FIG. 15 is a cross-sectional view along the line XV-XV in FIG. 14.

FIG. 16 is a cross-sectional view showing a process step after the process step of the liquid crystal display device 300 shown in FIGS. 13 to 15.

FIG. 17 is a plan view of a region where gate pads 112 are formed in the process step shown in FIG. 16.

FIG. 18 is a cross-sectional view along the line XVIII-XVIII shown in FIG. 17.

FIG. 19 is a cross-sectional view showing a process step after the process step shown in FIGS. 16 to 18.

FIG. 20 is a plan view of the peripheral region 105 during the process step shown in FIG. 19.

FIG. 21 is a cross-sectional view along the line XXI-XXI in FIG. 20.

FIG. 22 is a cross-sectional view showing a process step after the process step shown in FIGS. 19 to 21.

FIG. 23 is a plan view of the peripheral region 105 during the process step shown in FIG. 22.

FIG. 24 is a cross-sectional view along the line XXIV-XXIV in FIG. 23.

FIG. 25 is a cross-sectional view along the line XXV-XXV in FIG. 23.

FIG. 26 is a plan view of the peripheral region 105 in a liquid crystal display device according to Embodiment 2.

FIG. 27 is a cross-sectional view along the line XXVII-XXVII in FIG. 26.

FIG. 28 is a cross-sectional view along the line XXVIII-XXVIII in FIG. 26.

FIG. 29 is a cross-sectional view along the line XXIX-XXIX in FIG. 26.

FIG. 30 shows a first process step of the process steps of a liquid crystal display device 300 according to Embodiment 2, and is a plan view of the peripheral region 105.

FIG. 31 is a cross-sectional view along the line XXXI-XXXI shown in FIG. 30.

FIG. 32 is a plan view of the peripheral region 105 showing a process step after the process step shown in FIGS. 30 and 31.

FIG. 33 is a cross-sectional view along the line XXXIII-XXXIII in FIG. 32.

FIG. 34 is a cross-sectional view along the line XXXIV-XXXIV in FIG. 32.

FIG. 35 is a plan view of the peripheral region 105 showing a process step after the process step shown in FIGS. 32 to 34.

FIG. 36 is a cross-sectional view along the line XXXVI-XXXVI shown in FIG. 35.

FIG. 37 is a cross-sectional view along the line XXXVII-XXXVII shown in FIG. 35.

FIG. 38 is a plan view of the peripheral region 105 showing a process step after the process step shown in FIGS. 35 to 37.

FIG. 39 is a cross-sectional view along the line XXXIX-XXXIX in FIG. 38.

FIG. 40 is a cross-sectional view along the line XL-XL in FIG. 38.

FIG. 41 is a cross-sectional view along the line XLI-XLI in FIG. 38

FIG. 42 is a plan view of the peripheral region 105 in a liquid crystal display device 300 according to Embodiment 3.

FIG. 43 is a cross-sectional view along the line XLIII-XLIII in FIG. 42.

FIG. 44 is a cross-sectional view along the line XLIV-XLIV in FIG. 42.

FIG. 45 is a cross-sectional view along the line XLV-XLV in FIG. 42.

FIG. 46 is a plan view of the peripheral region 105 showing a step of forming gate lines and gate pads.

FIG. 47 is a cross-sectional view along the line XLVII-XLVII in FIG. 46.

FIG. 48 is a plan view of the peripheral region 105 showing a process step after the process step shown in FIGS. 46 and 47.

FIG. 49 is a cross-sectional view along the line XLIX-XLIX in FIG. 48.

FIG. 50 is a plan view of the peripheral region 105 showing a process step after the process step shown in FIGS. 48 and 49.

FIG. 51 is a cross-sectional view along the line LI-LI in FIG. 50.

FIG. 52 is a plan view of the peripheral region 105 showing a process step after the process step shown in FIGS. 50 and 51.

FIG. 53 is a cross-sectional view along the line LIII-LIII in FIG. 52.

FIG. 54 is a cross-sectional view along the line LIV-LIV in FIG. 52.

FIG. 55 is a plan view of the peripheral region 105 showing a modification example of the liquid crystal display device 300 of Embodiment 3.

FIG. 56 is a cross-sectional view along the line LVI-LVI in FIG. 55.

FIG. 57 is a cross-sectional view along the line LVII-LVII in FIG. 55.

FIG. 58 is a cross-sectional view along the line LVIII-LVIII in FIG. 55.

FIG. 59 is a cross-sectional view of a liquid crystal display device 300 according to Embodiment 4 of the present invention.

FIG. 60 is a plan view of the peripheral region 105 in the liquid crystal display device 300 shown in FIG. 59.

FIG. 61 is a cross-sectional view along the line LXI-LXI in FIG. 60.

FIG. 62 is a cross-sectional view along the line LXII-LXII in FIG. 60.

FIG. 63 is a cross-sectional view when a source electrode 135, a drain electrode 136, and a drain pad section 118 are formed during a process step of the liquid crystal display device 300 of Embodiment 4.

FIG. 64 is a plan view of the peripheral region 105 during the process step shown in FIG. 63.

FIG. 65 is a cross-sectional view along the line LXV-LXV shown in FIG. 64.

FIG. 66 is a cross-sectional view showing a process step after the process step shown in FIGS. 63 to 65.

FIG. 67 is a plan view of the peripheral region 105 during the process step shown in FIG. 66.

FIG. 68 is a cross-sectional view along the line LXVIII-LXVIII in FIG. 67.

FIG. 69 is a cross-sectional view along the line LXIX-LXIX in FIG. 67.

### DETAILED DESCRIPTION OF EMBODIMENTS

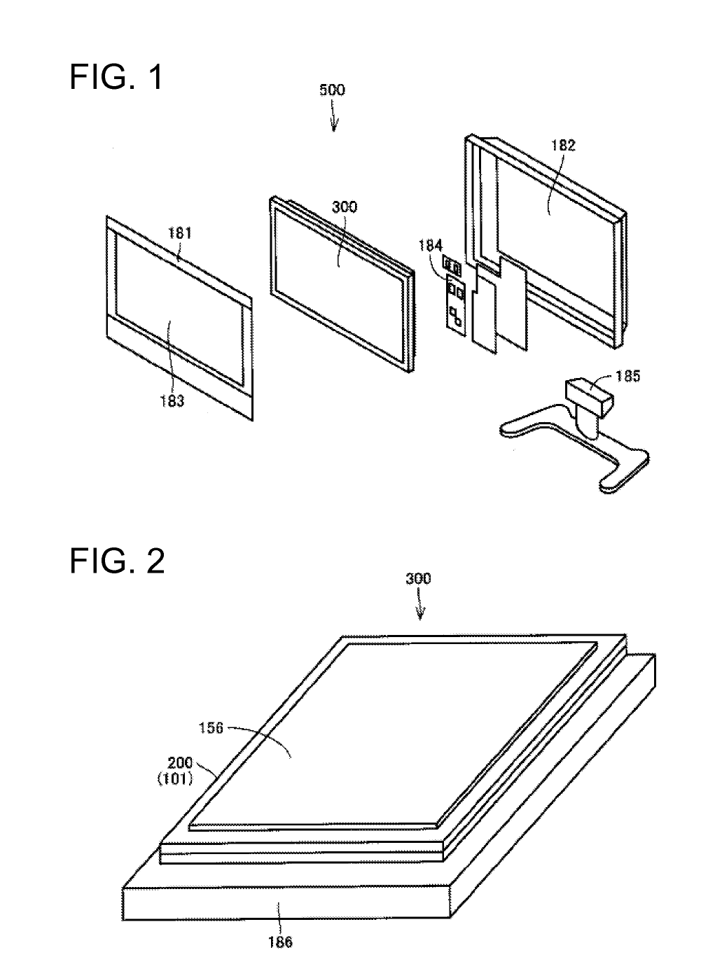

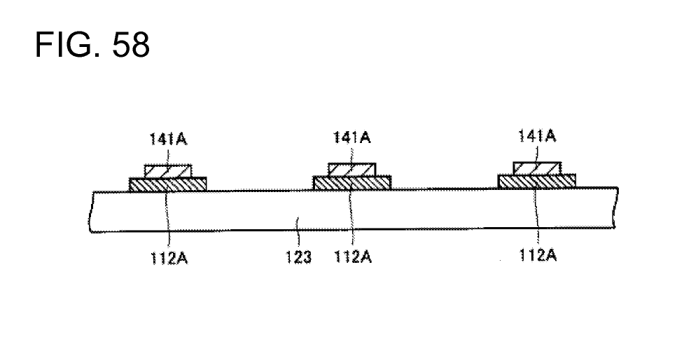

A liquid crystal display device and a method of manufacturing a liquid crystal display device according to embodiments of the present invention are described using FIGS. 1 to 58.

When a number, a quantity, and the like are mentioned in embodiments described below, the scope of the present invention is not necessarily limited to such number, quantity, or the like unless they are otherwise described as such. Furthermore, in the embodiments below, unless otherwise described as such, the respective components are not necessarily required for the present invention. Furthermore, if a plurality of embodiments are present below, unless otherwise described as such, various features of the respective embodiments can be appropriately combined without departing from the scope of the invention.

### Embodiment 1

FIG. 1 is an exploded perspective view showing a configuration of a television receiver 500 according to Embodiment 1 of the present invention. As shown in FIG. 1, the television receiver 500 has a case 181 disposed on the front surface side, a case 182 disposed on the back surface side, a liquid crystal display device 300 disposed between the case 181 and the case 182, an operation circuit 184, and a support member 185.

The liquid crystal display device 300 is enclosed by the case 181 and the case 182, and is held between the case 181 and the case 182.

In the case 181, an opening 183 is formed, and an image displayed on the liquid crystal display device 300 can be transmitted to the outside. In the case 182, the operation circuit 184 for operating the liquid crystal display device 300 is provided. The case 182 is supported by the support member 185.

FIG. 2 is a perspective view schematically showing the liquid crystal display device 300. As shown in FIG. 2, the liquid crystal display device 300 has a liquid crystal display element 200 that includes a liquid crystal display panel 101, a polarizing plate 156 mounted on one of the main surfaces of the liquid crystal display panel 101, a polarizing plate mounted on the other main surface of the liquid crystal display panel 101, and a backlight unit 186 that irradiates the liquid crystal display panel 101 with light.

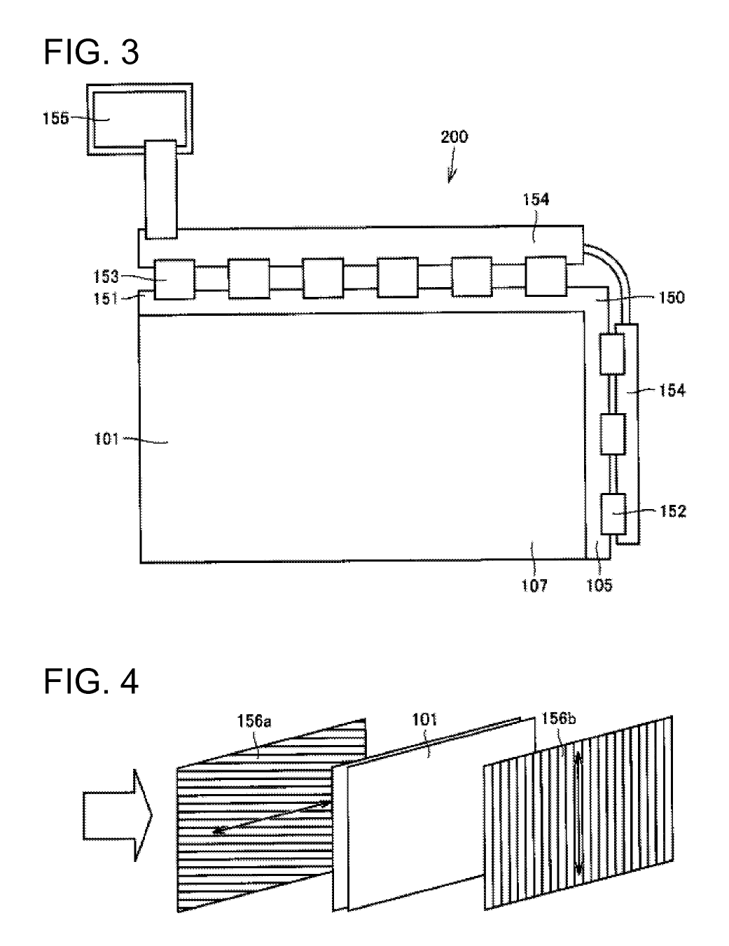

FIG. 3 is a plan view schematically showing the liquid crystal display element 200. As shown in FIG. 3, the liquid crystal display element 200 has the liquid crystal display panel 101, gate drivers 152 connected to a gate terminal section 150 of the liquid crystal display panel 101, source drivers 153 connected to a source terminal section 151 of the liquid crystal display panel 101, a printed substrate wiring 154 to which the gate drivers 152 and the source drivers 153 are connected, and a display control circuit 155 to which the printed substrate wiring 154 is connected.

FIG. 4 is an exploded perspective view showing an arrangement state of the liquid crystal display panel 101 and the polarizing plates 156. As shown in FIG. 4, a polarizing plate 156 a is mounted on one of the main surfaces of the liquid crystal display panel 101, and another polarizing plate 156b is mounted on the other main surface of the liquid crystal display panel 101.

Here, the polarizing axis direction of the polarizing plate 156a and the polarizing axis direction of the polarizing plate 156b are configured to be orthogonal to each other. Light from the backlight unit 186 shown in FIG. 2 is irradiated onto the polarizing plate 156a.

The liquid crystal display panel 101 includes an active matrix substrate, an opposite substrate that is disposed to face the active matrix substrate with a space therebetween, and a liquid crystal layer encapsulated between the active matrix substrate and the opposite substrate.

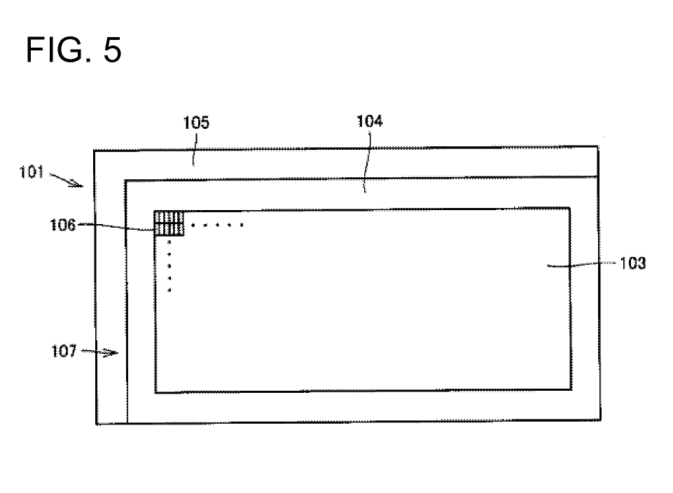

FIG. 5 is a plan view of the liquid crystal display panel 101. As shown in FIG. 5, the liquid crystal display panel 101 includes a pixel arrangement region 107 having a display region 103 and a non-display region 104 and a peripheral region 105 located in the periphery of the pixel arrangement region 107.

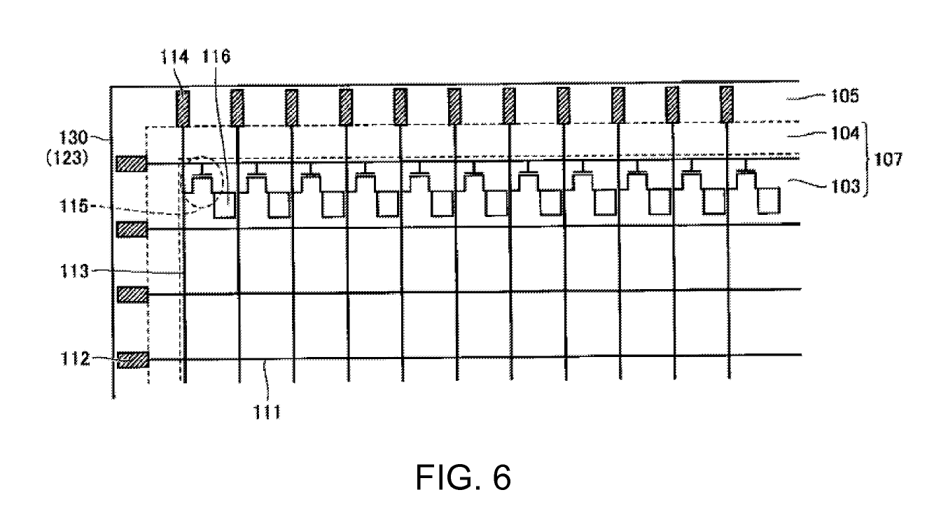

The display region 103 is a region where images are displayed, and is formed of a plurality of pixels. The non-display region 104 is a region where images are not displayed, and is disposed in the periphery of the display region 103. FIG. 6 is a circuit diagram showing a thin film transistor array formed on an active matrix substrate 130.

The active matrix substrate 130 has a transparent substrate 123 that includes the pixel arrangement region 107 and the peripheral region 105 located in the periphery of the pixel arrangement region 107.

On the main surface of the transparent substrate 123, at a portion where the display region 103 of the pixel arrangement region 107 is located, a plurality of thin film transistors (switching elements) 115 are arranged. On the active matrix substrate 130, a plurality of gate lines (lead-out wires) 111 connected to gate electrodes of the thin film transistors 115 and a plurality of source wires (lead-out wires) 113 connected to source electrodes of the thin film transistors 115 are formed. Pixel electrodes 116 are connected to drain electrodes of the thin film transistors 115.

Generally, the active matrix substrate 130 is in a rectangular shape. The gate lines 111 extend in the lengthwise direction of the active matrix substrate 130. The plurality of gate lines 111 are formed at intervals in the widthwise direction of the active matrix substrate 130. The plurality of source lines 113 extend in the widthwise direction, and are formed at intervals in the lengthwise direction.

In a region surrounded by the gate lines 111 and the source lines 113, a single pixel electrode 116 is disposed.

The gate lines 111 are led out from the thin film transistors 115, and extend so as to reach the peripheral region 105 from the pixel arrangement region 107. Gate pads 112 are formed at portions of the gate lines 111 that are located on the peripheral region 105.

The source lines 113 are led out from the thin film transistors 115, and extend so as to reach the peripheral region 105 from the pixel arrangement region 107. Source pads 114 are formed at portions of the source lines 113 that are located on the peripheral region 105.

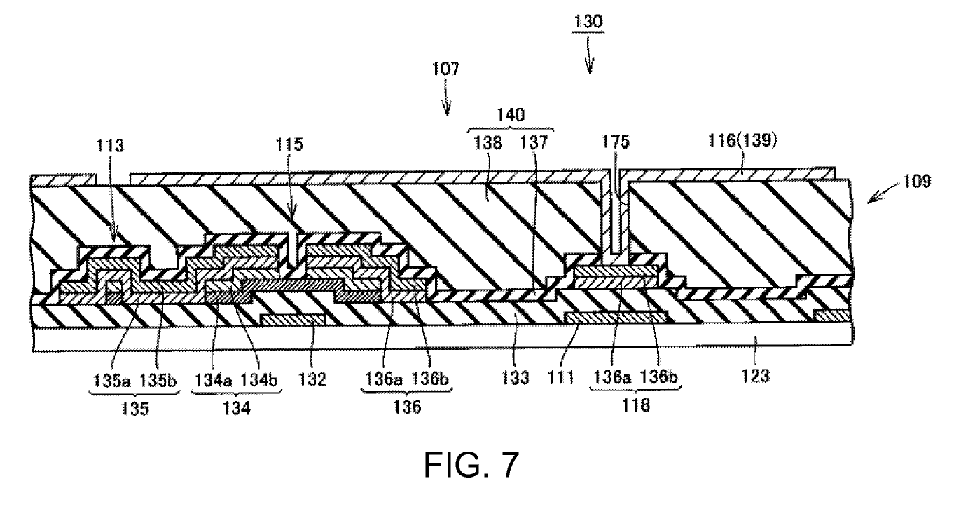

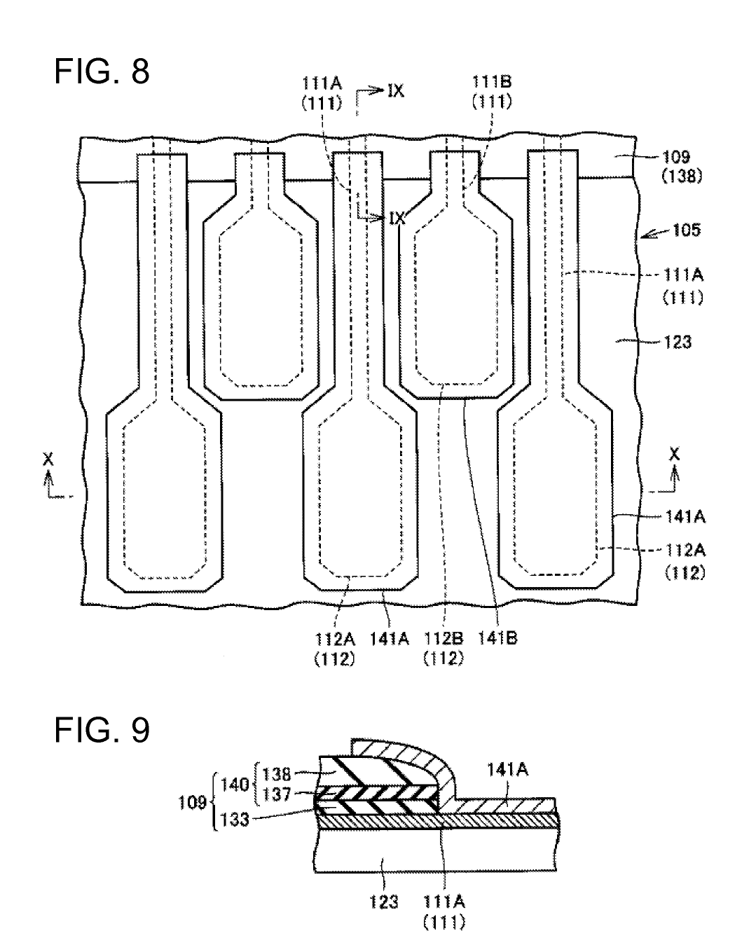

FIG. 7 is a cross-sectional view of the display region 103 of the active matrix substrate 130. FIG. 8 is a plan view of the peripheral region 105. FIG. 9 is a cross-sectional view along the line IX-IX in FIG. 8.

As shown in FIG. 7, the active matrix substrate 130 has the transparent substrate 123. The thin film transistor 115 is formed on the transparent substrate 123. The active matrix substrate 130 has a gate electrode 132 that is located inside the pixel arrangement region 107 and that is formed on the transparent substrate 123 and the gate line 111 that is formed on the transparent substrate 123 and that is connected to the gate electrode 132. In addition, as shown in FIG. 8, the active matrix substrate 130 has gate pads 112A and 112B that are located in the peripheral region 105 and that are formed on the transparent substrate 123. Further, as shown in FIGS. 7 and 9, the active matrix substrate 130 has a gate insulating film 133 formed so as to cover the gate electrode 132 and the gate line 111.

The gate electrode 132, the gate lines 111, and the gate pads 112 are formed integrally. The gate lines 111 connect the gate electrode 132 to the gate pads 112, and the gate pads 112 are formed at the end portions of the gate lines 111.

As shown in FIG. 7, the active matrix substrate 130 has a semiconductor layer 134 that is formed on the upper surface of the gate insulating film 133 and that is located above the gate insulating film 133, a drain electrode (first electrode) 136 formed on the semiconductor layer 134, and a source electrode 135 that is formed on the semiconductor layer 134 and that is formed so as to have a distance from the drain electrode 136.

The active matrix substrate 130 includes a multilayer film 109 that is located above the gate electrode 132 and that is formed by laminating a plurality of films. Here, the active matrix substrate 130 includes an interlayer insulating film 140 formed so as to cover the drain electrode 136 and the source electrode 135. The multilayer film 109 includes the interlayer insulating film 140. In the present embodiment, the multilayer film 109 includes the gate insulating film 133, the semiconductor layer 134, and the interlayer insulating film 140.

The thin film transistor 115 includes the gate electrode 132, the semiconductor layer 134, the source electrode 135, and the drain electrode 136.

The semiconductor layer 134 has an amorphous silicon (a-Si) film (i-layer) 134a formed on the gate insulating film 133 and an amorphous silicon (a-Si) film (n+ layer) 134b formed on the amorphous silicon film (i-layer) 134a. The amorphous silicon film (i-layer) 134a functions as a channel section of the thin film transistor 115.

In FIG. 7, a drain wire is connected to the drain electrode 136, and this drain wire is connected to a drain pad section 118. The pixel electrode 116 is connected to the drain pad section 118. The drain electrode 136, the drain wire, and the drain pad section 118 are formed integrally, and the drain electrode 136 and the pixel electrode 116 are electrically connected to each other. The pixel electrode 116 is formed of an ITO film.

The gate electrode 132, the gate lines 111, the gate pads 112, and the source pads 114 shown in FIG. 6 are all formed on a main surface of the transparent substrate 123, and are formed of the same first aluminum alloy material film.

The drain electrode 136, the drain wire, the drain pad section 118, the source electrode 135, and the source line 113 include second aluminum alloy material films 136b and 135b and metal films 136a and 135a formed below the aluminum alloy material films 136b and 135b. As shown in FIGS. 8 and 9, the gate pads 112 include the gate pads 112B and the gate pads 112A that are formed at locations farther away from the multilayer film 109 than the gate pads 112B. On the upper surfaces of the gate pads 112A and 112B, ITO films (ITO films for pad section) 141A and 141B are formed.

The gate pads 112A and 112B are both formed wider than the gate lines 111A and 111B. The ITO films 141A and 141B are formed on the peripheral surfaces and on the upper surfaces of the gate pads 112A and 112B and the gate lines 111A and 111B.

The difference between the potential of the first aluminum alloy material film, which forms the gate pads 112A and 112B, and that of the ITO (Indium Tin Oxide) films is set at approximately 1.0V, for example. On the other hand, the difference between the potential of an aluminum film and that of the ITO films is set at approximately 1.6V. Therefore, the first aluminum alloy material film forming the gate lines 111 and the like is less likely to corrode than the aluminum film. Even when the ITO films are formed directly on the gate pads 112, corrosion of the gate pads 112 can be suppressed.

Here, in conventional gate pads in which the gate pads 112 are formed by laminating three metal films Ti, Al, and Ti, the side surfaces of the middle film Al need to be covered by an insulating film to prevent contacts between the Al and the ITO films. On the other hand, when the gate pads 112 are formed of an aluminum alloy film, unlike the conventional gate pads, there is no need to cover the periphery of the gate pads using an insulating film. Therefore, the insulating film can be omitted.

In the active matrix substrate 130 according to Embodiment 1, the gate pads 112A and the main surface of the transparent substrate 123 located in the peripheries of the gate pads 112A are exposed from the multilayer film 109.

FIG. 10 is a cross-sectional view along the line X-X shown in FIG. 8. As shown in FIG. 10, the ITO films 141A are formed on the upper surfaces and the peripheral surfaces of the gate pads 112A. Furthermore, the ITO films 141A are formed on the main surface of the transparent substrate 123 located in the peripheries of the gate pads 112A across the peripheral surfaces and the upper surfaces of the gate pads 112A.

Even if the ITO films are formed on the peripheral surfaces of the gate pads 112A, corrosion of the gate pads 112A is suppressed. By forming the ITO films 141A on the peripheral surfaces of the gate pads 112A, contact areas between the ITO films 141A and the gate pads 112A can be increased.

In the peripheries of the gate pads 112A, the insulating film and the like are not formed. Therefore, steps formed in the ITO films 141A are approximately the thickness of the gate pads 112A.

This way, the steps formed in the ITO films 141A can be suppressed to be small. Thus, occurrence of disconnection, a crack, and the like of the ITO films 141A can be suppressed.

Between the gate pads 112A, 112B, and the gate drivers 152 shown in FIG. 3, an anisotropic conductive film is disposed. The anisotropic conductive film includes an insulating binder and a plurality of conductive particles distributed inside the binder. The gate pads 112A, 112B, and the gate drivers 152 are connected to the terminal section of the gate drivers 152 through the conductive particles inside the anisotropic conductive film. Because the multilayer film 109 is not formed in the peripheries of the gate pads 112A and 112B and on the gate pads 112A and 112B, the distance between the gate pads 112A and 112B and the terminal section of the gate drivers 152 can be made closer. Therefore, conductive particles having small diameters can be used.

When the conductive particles having small diameters are used, the number of the conductive particles arranged on the gate pads 112A and 112B increases, thereby securing the conductivity between the gate pads 112A, 112B, and the gate drivers 152.

In FIG. 8, the first aluminum alloy material film, which forms the gate lines 111A and 111B and the gate pads 112A and 112B, contains aluminum as the base material, an alloy component containing at least one type of element selected from a group constituted of cobalt (Co), rhodium (Rh), nickel (Ni), palladium (Pd), carbon (C), silicon (Si), germanium (Ge), and tin (Sn), and another component containing an element that is different from aluminum and the elements listed above. In the aluminum alloy material film, the sum of the elements in the alloy component and the elements in the other component is set to be three types of elements or more.

The first aluminum alloy material film can be patterned by wet etching, and in a step of forming the gate lines 111A and 111B and the gate pads 112A and 112B, dust can be prevented from generating. Therefore, the gate lines 111A and 111B and the gate pads 112A and 112B can be patterned in an excellent manner.

In FIG. 7, the difference between the potential of the second aluminum alloy material films 135b and 136b of the drain electrode 136, the drain wire, and the drain pad section 118 and that of the ITO films is set at approximately 1.0V, for example. Therefore, even when the ITO films are formed directly on the second aluminum alloy material films 135b and 136b, corrosion of the second aluminum alloy material films 135b and 136b is suppressed.

More specifically, the second aluminum alloy material films 135b and 136b also contain aluminum as the base material, an alloy component containing at least one type of element selected from a group constituted of cobalt (Co), rhodium (Rh), nickel (Ni), palladium (Pd), carbon (C), silicon (Si), germanium (Ge), and tin (Sn), and another component containing an element that is different from aluminum and the elements listed above. In the aluminum alloy material films, the sum of the elements in the alloy component and the elements in the other component is set to be three types of elements or more.

Both the second aluminum alloy material films 135b and 136b can be patterned by wet etching. When forming the respective wires, pads, and electrodes, dust can be prevented from generating, and patterning can be performed in an excellent manner. This way, the yield ratio of the active matrix substrate 130, the liquid crystal display device 300, and the like can be improved.

In the first aluminum alloy material film and the second aluminum alloy material films 135b and 136b, at least one type of element selected from the group constituted of cobalt (Co), rhodium (Rh), nickel (Ni), palladium (Pd), carbon (C), silicon (Si), germanium (Ge), and tin (Sn) is included as an alloy component. This way, the contact resistance with transparent conductive films such as the ITO films and the like can be improved.

Furthermore, elements that are different from aluminum, cobalt (Co), rhodium (Rh), nickel (Ni), palladium (Pd), carbon (C), silicon (Si), germanium (Ge), and tin (Sn) are included as the other component (first other component, second other component). This way, the sheet resistance can be reduced, and resistance to a chemical fluid can be improved.

As the other component, copper (Cu), lanthanum (La), boron (B), neodymium (Nd), silver (Ag), gold (Au), platinum (Pt), yttrium (Y), niobium (Nb), tungsten (W), and zirconium (Zr) can be used, for example.

FIG. 11 is a cross-sectional view schematically showing a contact site between the aluminum alloy material film 136b and the pixel electrode 116. As shown in FIG. 11, the aluminum alloy material film 136b includes a base material 119b and a plurality of deposits 119a.

The deposits 119a are conductive deposits in granular shapes. The deposits 119a are distributed from the inside of the base material 119b to the surface of the base material 119b. At portions of the surface of the second aluminum alloy material film 136b that are in contact with the pixel electrode 116, the deposits 119a are exposed from the surface of the base material 119b.

When the exposed deposits 119a come in contact with the pixel electrode 116, the contact resistance between the pixel electrode 116 and the second aluminum alloy material film 136b can be suppressed to be low.

Here, the deposits are AlxR_{Y} (X and Y are positive integers: R is any one element of cobalt, rhodium, nickel, palladium, carbon, silicon, germanium, and tin).

If at least Ni (nickel) is contained as the alloy component of the aluminum alloy material film 136b, for example, the deposits 119a become Al₃Ni.

Preferably, the alloy component containing at least one type of element selected from a group constituted of cobalt, rhodium, nickel, palladium, carbon, silicon, germanium, and tin contained in the second aluminum alloy material films 135b and 136b is set at 0.5 wt % or more. By using this alloy component, resistance to a developing solution can be secured when the second aluminum alloy material films 135b, 136b, and the ITO films are laminated. Therefore, corrosion of the second aluminum alloy material films 135b and 136b can be prevented from occurring, and the contact resistance between the second aluminum alloy material films 135b, 136b, and the ITO films can be suppressed to be low.

Furthermore, preferably, the alloy component containing at least one type of element selected from a group constituted of cobalt, rhodium, nickel, palladium, carbon, silicon, germanium, and tin is set at 4.5 wt % or less. By using this aluminum alloy material film, corrosion of the second aluminum alloy material films 135b and 136b can be prevented from occurring, and the contact resistance between the second aluminum alloy material films 135b, 136b, and the ITO films can be suppressed to be low.

As a specific example, nickel (Ni) is selected from a group constituted of cobalt, rhodium, nickel, palladium, carbon, silicon, germanium, and tin, for example. Then, an aluminum alloy material film constituted of 1.0 wt % nickel, 0.5 wt % copper (Cu), 0.3 wt % lanthanum (La), and aluminum (Al) can be used as the second aluminum alloy material films 135b and 136b. Here, nickel is preferably used as the alloy component.

The metal films 135a and 136a are formed on the lower surfaces of the second aluminum alloy material films 135b and 136b, and are formed between the second aluminum alloy material films 135b and 136b and the semiconductor layer 134.

The metal films 135a and 136a are formed of an element having a higher density than the density of the element in the synthetic metal of the second aluminum alloy material films 135b and 136b and the density of the element in the other component that is different from aluminum, cobalt, rhodium, nickel, palladium, carbon, silicon, germanium, and tin.

The metal films 135a and 136a are formed of molybdenum (Mo), for example. The metal films 135a and 136a prevent the alloy component contained in the second aluminum alloy material films 135b and 136b from reaching the semiconductor layer 134, and prevent the alloy component from diffusing inside the semiconductor layer 134. This way, changing of the Vth value of the thin film transistors 115 and the like can be suppressed.

As shown in FIG. 8 and the like, the active matrix substrate 130 has an ITO film 141 formed on the upper surfaces of the gate pads 112, and the gate pads 112 and the ITO film 141 are in direct contact with each other.

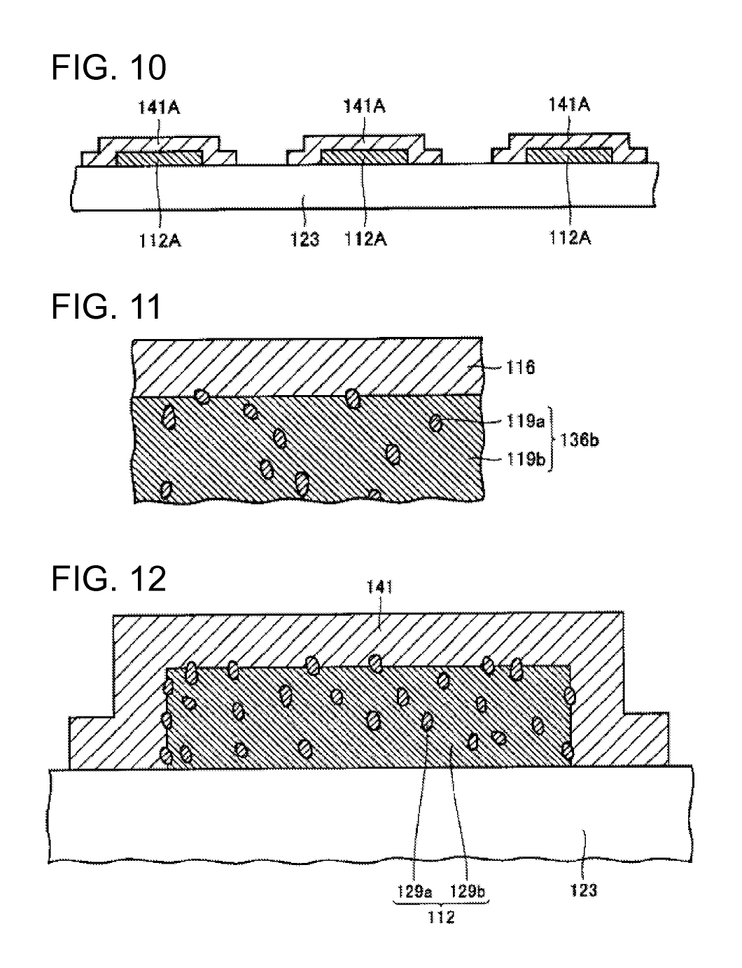

FIG. 12 is a cross-sectional view showing a contact site between the ITO film 141 and the gate pad 112 in detail. As shown in FIG. 12, the gate pad 112 has a base material 129b and a plurality of deposits 129a.

The deposits 129a are conductive deposits in granular shapes. The deposits 129a are distributed from the inside of the base material 129b to the surface of the base material 129b.

The deposits 129a are formed so as to be exposed from the peripheral surfaces and the upper surface of the gate pad 112. Therefore, at portions of the surfaces of the gate pad 112 that are in contact with the ITO film 141, the deposits 129a are exposed, and the deposits 129a and the ITO film 141 are in contact with each other. Because the deposits 129a and the ITO film 141 are in contact with each other, the contact resistance between the ITO film 141 and the gate pad 112 is reduced.

Preferably, the alloy component containing at least one type of element selected from a group constituted of cobalt, rhodium, nickel, palladium, carbon, silicon, germanium, and tin contained in the gate pad 112 is set at 0.5 wt % or more. By using the alloy component, resistance to a developing solution can be secured when the gate pad 112 and the ITO film are laminated. This way, corrosion of the gate pad 112 can be prevented from occurring, and the contact resistance between the gate pad 112 and the ITO film can be suppressed to be low.

Further, preferably, the alloy component containing at least one type of element selected from a group constituted of cobalt, rhodium, nickel, palladium, carbon, silicon, germanium, and tin is set at 0.5 wt % or more and 4.5 wt % or less. By using this aluminum alloy material film, corrosion of the gate pad 112 can be prevented from occurring, and the contact resistance between the gate pad 112 and the ITO film can be suppressed to be low.

As the aluminum alloy material film, an Al—Ni—Cu—La alloy material film containing aluminum (Al) as the base material, nickel (Ni) as an alloy component, and copper (Cu) and lanthanum (La) as other components can be suggested, for example.

As another example, an Al—Ni—Ge—Nd alloy material film containing aluminum (Al) as the base material, nickel (Ni) and germanium (Ge) as alloy components, and neodymium (Nd) as the other component can be suggested.

As another example, an Al—Co—Ge—Nd alloy material film containing aluminum (Al) as the base material, cobalt (Co) and germanium (Ge) as alloy components, and neodymium (Nd) as the other component can be suggested.

As another example, as the aluminum alloy material film, an Al—Ni—B alloy material film containing aluminum (Al) as the base material, nickel (Ni) as an alloy component, and boron (B) as the other component can be suggested.

The above-mentioned aluminum alloy material films are aluminum alloy material films having aluminum as the base material, an alloy component containing at least one type of element selected from a group constituted of cobalt (Co), rhodium (Rh), nickel (Ni), palladium (Pd), carbon (C), silicon (Si), germanium (Ge), and tin (Sn), and another component containing an element that is different from aluminum and the elements listed. The “element that is different from aluminum and the elements listed” is set to be copper (Cu), lanthanum (La), boron (B), neodymium (Nd), silver (Ag), gold (Au), platinum (Pt), yttrium (Y), niobium (Nb), tungsten (W), and zirconium (Zr). According to these aluminum alloy material films, the contact resistance with the ITO film can be reduced, and the sheet resistance can be reduced. Furthermore, resistance to a chemical fluid can be secured.

Furthermore, as the “element that is different from aluminum and the elements listed”, copper (Cu), lanthanum (La), boron (B), or neodymium (Nd) preferably are used.

Furthermore, of the above-mentioned aluminum alloy material films, the Al—Ni—Cu—La alloy material film, the Al—Ni—Ge—Nd alloy material film, and the Al—Co—Ge—Nd alloy material film contain aluminum as the base material, an alloy component containing at least one type of element selected from a group constituted of cobalt, rhodium, nickel, palladium, carbon, silicon, germanium, and tin, and another component containing an element that is different from aluminum and the elements listed. The sum of the elements in the alloy component and the elements in the other component is set to be three types of elements or more.

According to these aluminum alloy material films, the contact resistance with the ITO film can be reduced, and the sheet resistance can be reduced. Furthermore, resistance to a chemical fluid can be secured.

Further, as a specific example, nickel is selected from the group constituted of cobalt, rhodium, nickel, palladium, carbon, silicon, germanium, and tin, for example. Then, an aluminum alloy constituted of 1.0 wt % nickel (Ni), 0.5 wt % copper (Cu), 0.3 wt % lanthanum (La), and aluminum (Al) can be used as gate pads 112. In this example, nickel is used as the alloy component of the aluminum alloy material, and copper and lanthanum are used as other components.

The deposits 129a shown in FIG. 12 are formed so as to be exposed from portions of the surfaces of gate lines 111A and 111B that are exposed from the multilayer film 109. Furthermore, the contact resistance between the gate lines 111A and 111B and the ITO films 141A and 141B is reduced.

Here, the distribution density of the deposits 129a formed in the first aluminum alloy material film, which forms the gate pads 112 and the source pads, is higher than the distribution density of the deposits 119a formed in the second aluminum alloy material film 136b. Here, the distribution density of deposits is a volume of the deposits contained per unit volume of the aluminum alloy material film.

Thus, in an interface between the ITO film 141 and the gate pad 112, the area in which the deposits 129a are exposed from the base material 129b per unit area is larger than the area in which the deposits 119a are exposed from the base material 119b per unit area in an interface between the pixel electrode 116 and the second aluminum alloy material film 136b.

As shown in FIG. 8, the gate lines 111A and 111B located on the peripheral region 105 are exposed from the multilayer film 109. A planarization film 138 included in the multilayer film 109 is formed of an acrylic-based organic material. When the planarization film 138 absorbs moisture, it swells and becomes more likely to be detached. Therefore, detaching of the planarization film 138 can be suppressed by making the area where the planarization film 138 is formed smaller.

The ITO films 141A and 141B are formed so as to cover the gate pads 112A and 112B and the gate lines 111A and 111B.

As described above, the ITO films are formed so as to cover the gate lines 111A and 111B and the gate pads 112A and 112B. This way, during a step of patterning the ITO films and the like, the gate lines 111A and 111B and the gate pads 112A and 112B can be protected.

Here, the gate line 111A is connected to the thin film transistor 115 shown in FIG. 7. The gate line 111B is connected the thin film transistor 115, which is different from the thin film transistor 115 to which the gate line 111A is connected. The gate pads 112A are formed so as to be farther away from the multilayer film 109 than the gate pads 112B.

The gate pads 112A and the gate pads 112B are disposed alternately. By disposing the gate pads 112A and the gate pads 112B in this manner, distances between the gate pads 112A and the gate pads 112B can be secured. By securing the distances between the gate pads 112A and 112B, it is possible to prevent the ITO films 141A and the ITO films 141B from being united during a process of patterning the ITO films 141A and the ITO films 141B.

In FIG. 7, in the pixel arrangement region 107, the active matrix substrate 130 includes the interlayer insulating film 140 formed so as to cover the source electrode 135, the drain electrode 136, and the drain pad section 118.

The interlayer insulating film 140 includes a passivation film 137 and the planarization film 138 formed on the passivation film 137. The passivation film 137 is formed on the gate insulating film 133 so as to cover the source electrode 135, the drain electrode 136, and the drain pad section 118.

The passivation film 137 is formed of a silicon nitride film, and is formed by a CVD method at approximately 250 degrees, for example. Here, the passivation film 137 and the gate insulating film 133 are both formed of a silicon nitride film. However, the composition of the gate insulating film 133 is denser than that of the passivation film 137. The planarization film 138 is formed of an organic material such as an acrylic-base synthetic resin or the like.

In the interlayer insulating film 140, a contact hole 175 formed so as to reach the drain pad section 118 is formed. The pixel electrode 116 is formed so as to reach the upper surface of the aluminum alloy material film 136b from the upper surface of the planarization film 138 through the inner peripheral surface of the contact hole 175.

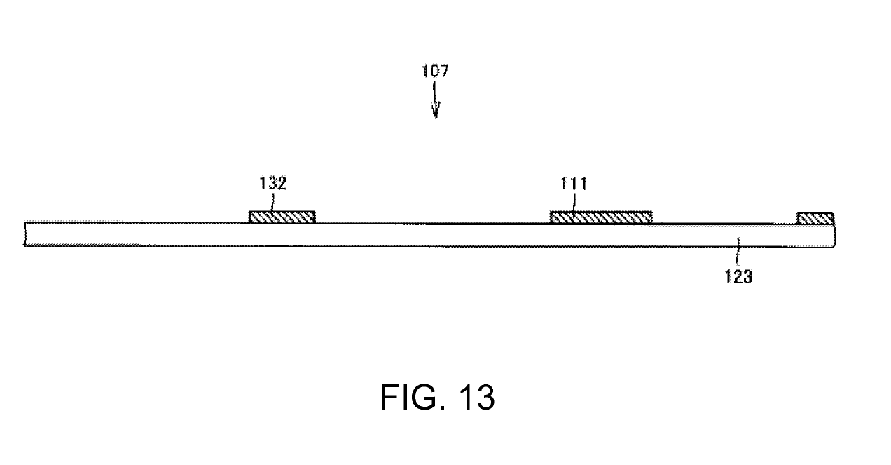

Using FIGS. 13 to 25, a method of manufacturing a liquid crystal display device 300 according to Embodiment 1 of the present invention is described.

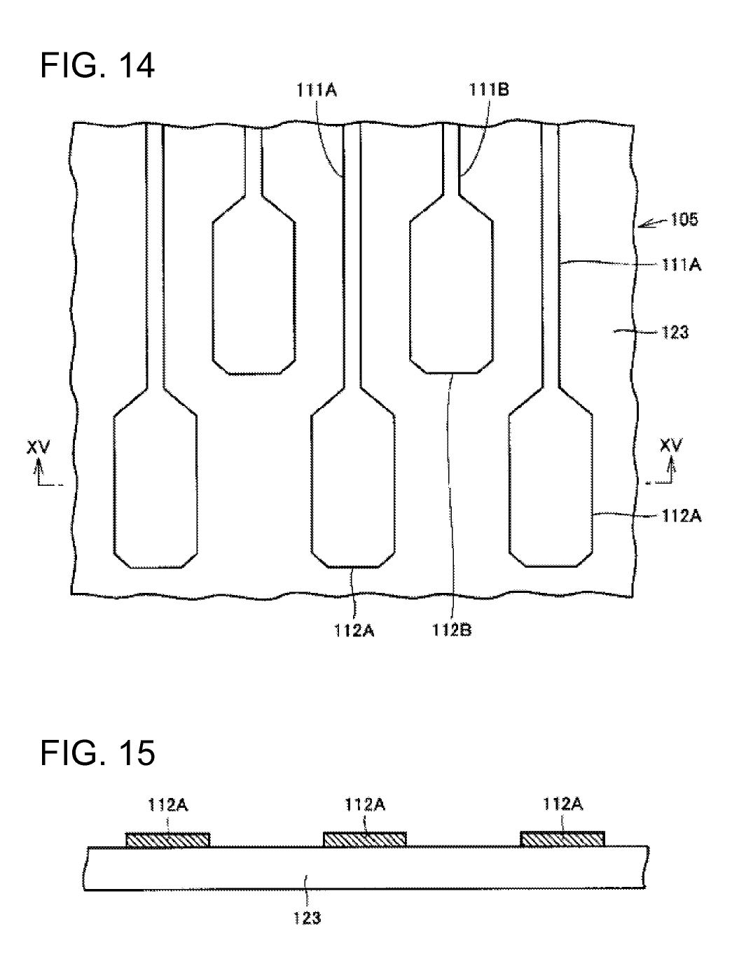

FIG. 13 is a cross-sectional view showing a first process step of the process steps of the liquid crystal display device 300. FIG. 14 is a plan view of a region where the gate pads 112A and 112B are formed during the first process step of the process steps of the liquid crystal display device 300 shown in FIG. 13. FIG. 15 is a cross-sectional view along the line XV-XV in FIG. 14.

As shown in FIGS. 13 and 14, the transparent substrate 123 having a main surface is prepared. Then, on the main surface of the transparent substrate 123, an aluminum alloy material film is formed using a sputtering deposition method, for example.

Then, the formed aluminum alloy material film is patterned to form the gate electrode 132, the gate lines 111A and 111B, the gate pads 112A and 112B, and source pads on the main surface of the transparent substrate 123. As described above, the aluminum alloy material film can be patterned by wet etching, and the gate lines 111A and 111B, the gate pads 112A and 112B, the gate electrode 132, and the source pads can be formed in an excellent manner.

Here, the film thicknesses of the gate lines 111, the gate pads 112, the gate electrode 132, and the source pads are set at approximately 2000 Å, for example.

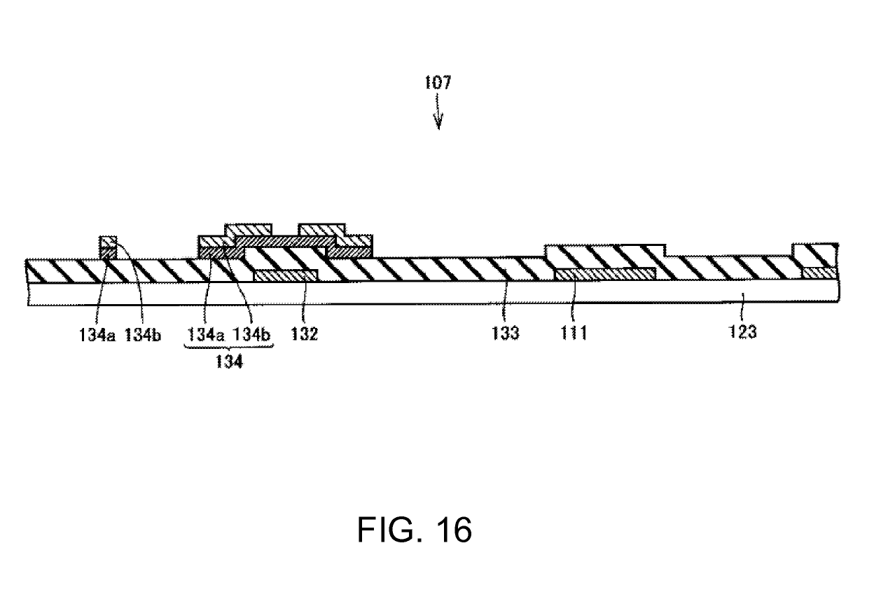

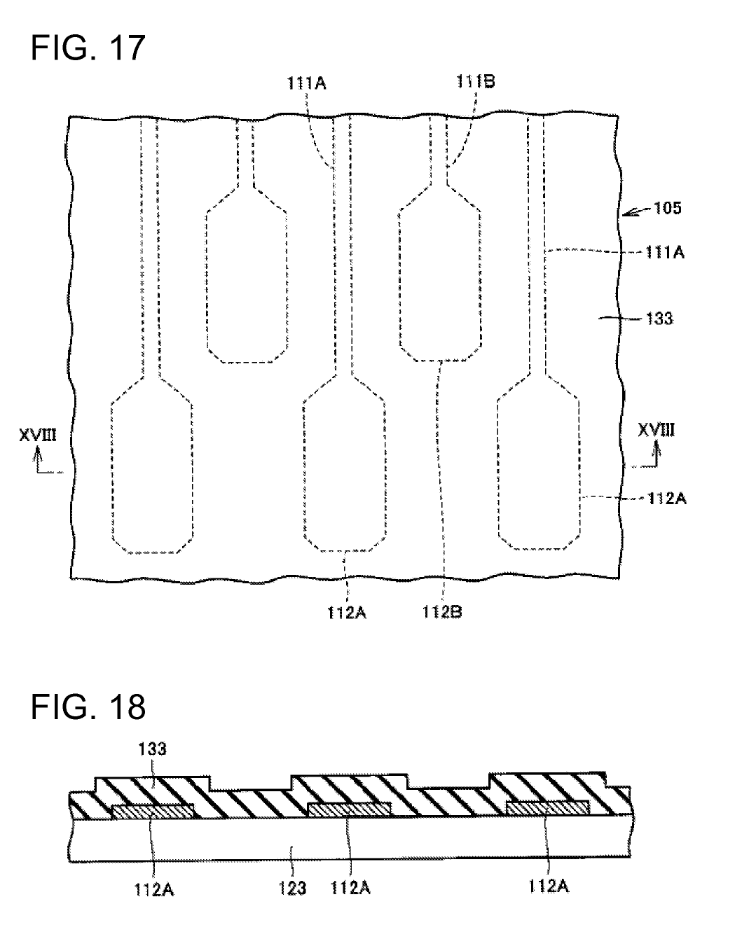

FIG. 16 is a cross-sectional view showing a process step after the process step of the liquid crystal display device 300 shown in FIGS. 13 to 15. FIG. 17 is a plan view of a region where the gate pads 112 are formed during the process step shown in FIG. 16. FIG. 18 is a cross-sectional view along the line XVIII-XVIII shown in FIG. 17.

As shown in FIGS. 16 to 18, the gate insulating film 133 is formed on the main surface of the transparent substrate 123 so as to cover the gate electrode 132, the gate lines 111, the gate pads 112, and the source pads.

The gate insulating film 133 is formed by a CVD method, for example. The temperature for forming the film is set at approximately 350° C., for example.

When forming the gate insulating film 133, the temperature inside the chamber increases, and the temperatures of the gate electrode 132, the gate lines 111, the gate pads 112, and the source pads, which have been already formed, also increase. Then, the gate electrode 132, the gate lines 111, the gate pads 112, and the source pads cool down, thereby forming conductive deposits inside the gate electrode 132, the gate lines 111, the gate pads 112, and the source pads. The deposits are AlₓR_{Y} (x and Y are positive integers: R is any one of Co, Rh, Ni, Pd, C, Si, Ge, and Sn).

Here, the gate insulating film 133 is formed of a silicon nitride film, and the film thickness of the gate insulating film 133 is set at approximately 4100 Å, for example.

Then, after the gate insulating film 133 is formed, an amorphous silicon film (i-layer) and an amorphous silicon film (n+ layer) are formed in this order by a CVD method on the upper surface of the gate insulating film 133. Then, the amorphous silicon film (i-layer) and the amorphous silicon film (n+ layer) are patterned. This way, the semiconductor layer 134 including the amorphous silicon film (i-layer) 134a and the amorphous silicon film (n+ layer) 134b is formed in the pixel arrangement region 107. The film thickness of the amorphous silicon film (i-layer) 134a is set at approximately 1750 Å, for example, and the amorphous silicon film (n+ layer) 134b is set at approximately 550 Å, for example.

At this time, as shown in FIGS. 17 and 18, the amorphous silicon film (i-layer) 134a and the amorphous silicon film (n+ layer) 134b formed on the peripheral region 105 are removed. This way, in the peripheral region 105, the gate insulating film 133 becomes exposed.

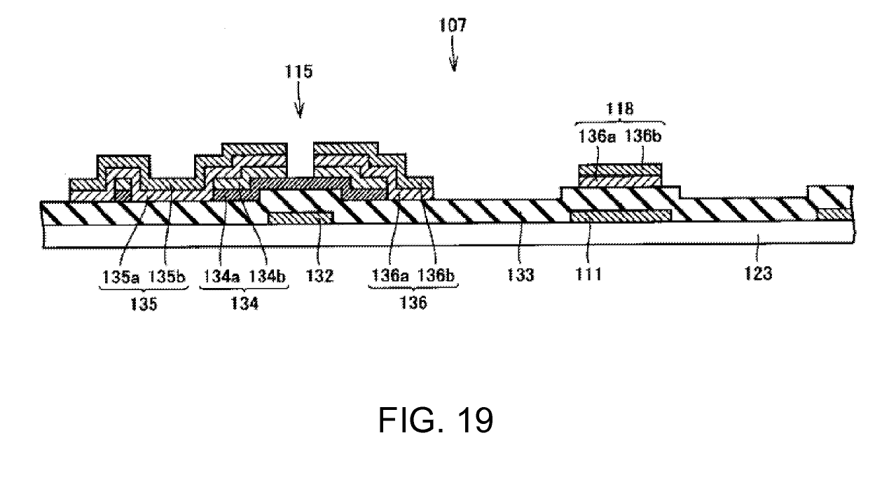

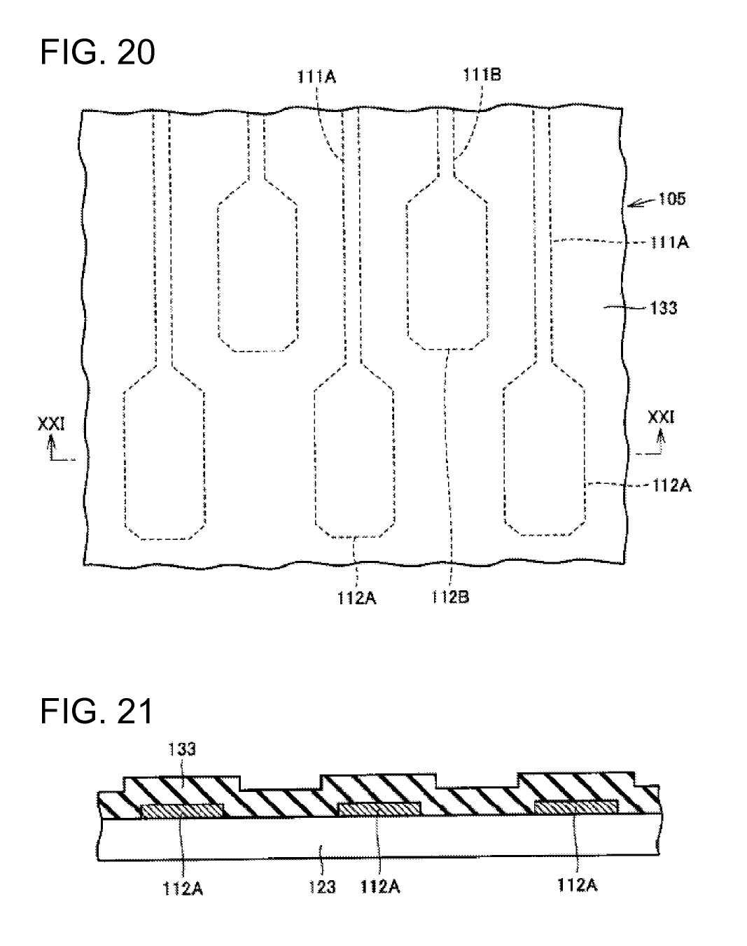

FIG. 19 is a cross-sectional view showing a process step after the process step shown in FIGS. 16 to 18. FIG. 20 is a plan view of the peripheral region 105 during the process step shown in FIG. 19. FIG. 21 is a cross-sectional view along the line XXI-XXI in FIG. 20. In FIGS. 19 to 20, the metal film 136a formed of molybdenum (Mo) and the second aluminum alloy material film 136b are formed in this order.

Then, the metal film 135a and the second aluminum alloy material film 136b, which are laminated, are patterned using a mask. Here, the metal film 135a and the second aluminum alloy material film 136b can be patterned by wet etching, and the source electrode 135 and the drain electrode 136 can be patterned in an excellent manner.

As described above, by patterning the metal film 135a and the second aluminum alloy material film 135b, the metal film 135a and the second aluminum alloy material film 135b formed on the peripheral region 105 are removed. Therefore, as shown in FIGS. 20 and 21, the gate insulating film 133 is exposed in the peripheral region 105.

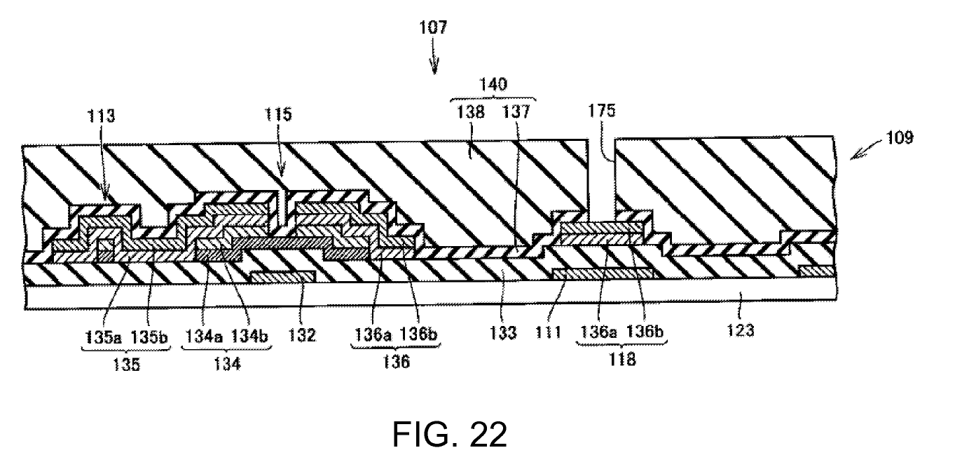

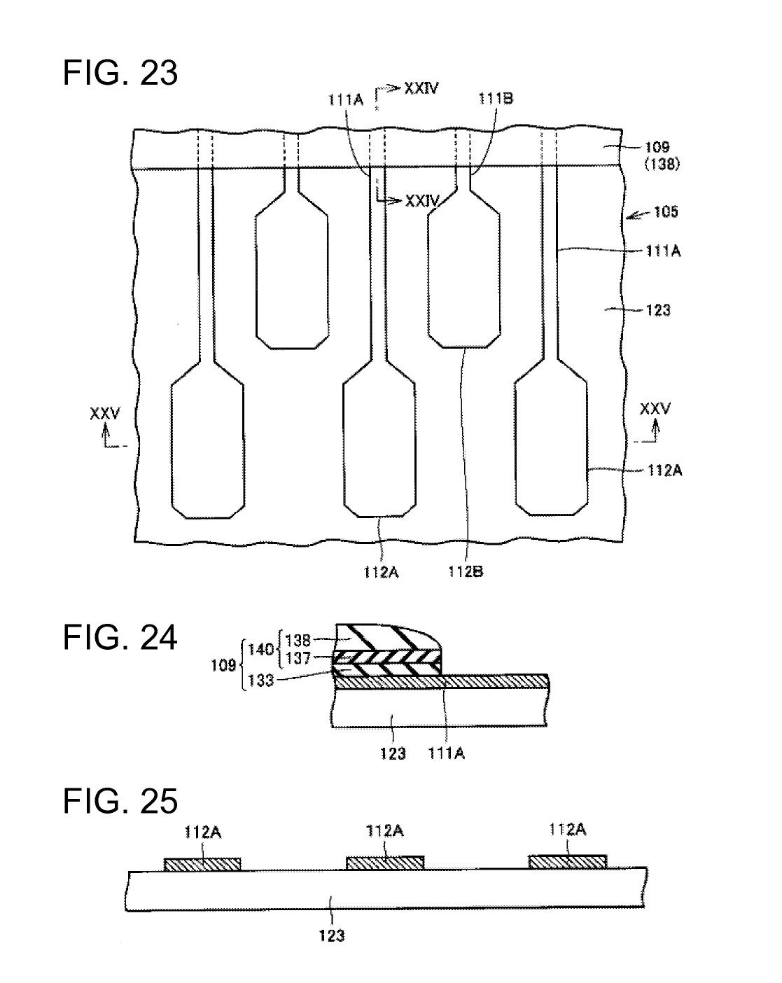

FIG. 22 is a cross-sectional view showing a process step after the process step shown in FIGS. 19 to 21. FIG. 23 is a plan view of the peripheral region 105 during the process step shown in FIG. 22. FIG. 24 is a cross-sectional view along the line XXIV-XXIV in FIG. 23. FIG. 25 is a cross-sectional view along the line XXV-XXV.

In FIGS. 22 to 24, first, the passivation film 137, which is a silicon nitride film, is formed by a CVD method. The temperature for forming the film is set at approximately 250 degrees, for example.

The passivation film 137 is formed so as to cover the second aluminum alloy material films 135b, 136b, and the gate insulating film 133.

Because of the heat generated when the passivation film 137 is formed, the second aluminum alloy material film 135b becomes also heated. This way, deposits are formed in the second aluminum alloy material film 135b.

Here, the film formation temperature of the passivation film 137 is lower than the film formation temperature of the gate insulating film 133. Because of this, the deposition density of deposits formed inside the second aluminum alloy material films 135b and 136b is lower than the deposition density of the deposits formed in the first aluminum alloy material film, which constitutes the gate lines 111 and the like. Here, the deposition density is the volume of the deposits formed per unit volume.

After the passivation film 137 is formed, the planarization film 138 is formed. The planarization film 138 is formed of an acrylic-base organic material, for example. The planarization film 138 is patterned to remove portions located on the peripheral region 105. This way, the planarization film 138 located on the source pads and the gate pads 112 are removed. Furthermore, during the patterning, a hole is patterned in a portion of the planarization film 138 that is located above the drain pad section 118.

Using the patterned planarization film 138 as a mask, the passivation film 137 and the like are patterned.

In the peripheral region 105, the passivation film 137 and the gate insulating film 133 are removed, and the gate pads 112A and 112B and the gate lines 111A and 111B are exposed. Here, the gate insulating film 133 and the passivation film 137 are both formed of silicon nitride films. In the peripheral region 105, both the gate insulating film 133 and the passivation film 137 are removed.

On the other hand, as shown in FIG. 22, in the pixel arrangement region 107, the contact hole 175 is formed, whereas most of the planarization film 138 and the passivation film 137 are left. This way, in the pixel arrangement region 107, the multilayer film 109 including the gate insulating film 133, which is located above the gate electrode 132 and the gate line 111, the semiconductor layer 134, the source electrode 135, the drain electrode 136, the passivation film 137, and the planarization film 138 is formed.

As described above, the multilayer film 109 is not formed in the peripheral region 105. Therefore, as shown in FIG. 23 and the like, the gate lines 111A and 111B and the gate pads 112A and 112B located on the peripheral region 105, as well as the main surface of the transparent substrate 123 located in the peripheries of the gate lines 111A and 111B and the gate pads 112A and 112B are exposed to the outside.

Here, in the pixel arrangement region 107, a portion of the upper surface of the drain pad section 118 located at a bottom portion of the contact hole 175 is exposed. Specifically, a portion of the upper surface of the second aluminum alloy material film 135b of the drain pad section 118 is exposed.

Surfaces of the exposed portions of the gate lines 111A and 111B, the gate pads 112A and 112B, and the drain pad section 118 are treated with an alkali solution.

The gate lines 111A and 111B and the gate pads 112A and 112B are formed of the first aluminum alloy material film. The deposits formed in the aluminum alloy material film become exposed to the surface by the above-mentioned solution.

Similarly, in the second aluminum alloy material film 135b of the drain pad section 118, deposits become exposed to the surface exposed by the contact hole 175.

As described, while deposits are exposed on surfaces of the portions of the gate lines 111A and 111B that are exposed from the multilayer film 109, the gate pads 112A, 112B, and a portion of the second aluminum alloy material film 135b, an ITO film is formed on the gate lines 111A, 111B, the gate pads 112A, 112B, and the multilayer film 109.

Then, the ITO film is patterned to form the pixel electrode 116 shown in FIG. 7 and the ITO films 141A and 141B shown in FIG. 8.

This way, ITO films are formed on the surfaces on which the deposits are formed, and the contact resistance between the ITO film and the gate pads 112 can be reduced.

As shown in FIG. 8, the ITO films 141A and 141B are formed so as to cover the gate pads 112A and 112B and the gate lines 111A and 111B. Thus, when patterning the ITO films, the gate pads 112A and 112B and the gate lines 111A and 111B are prevented from touching an etchant, thereby suppressing disconnection of the gate pads 112A and 112B and the gate lines 111A and 111B.

Here, as shown in FIGS. 9 and 10, the ITO films 141A and 141B are formed so as to reach above the multilayer film 109. Portions of the gate lines 111A and 111B where an outer peripheral edge of the multilayer film 109 is located are prevented from being exposed from the ITO films 141A and 141B. Therefore, when patterning the ITO films, disconnection of the gate lines 111A and 111B caused by an etching solution can be suppressed.

Here, in the edge of the multilayer film 109 on the peripheral region 105 side, the gate insulating film 133 and the passivation film 137 are laminated, and the semiconductor layer 134 is not formed between the gate insulating film 133 and the passivation film 137.

The gate insulating film 133 and the passivation film 137 are both formed of a silicon nitride film. Therefore, the peripheral edge of the multilayer film 109 is either standing vertically or gently inclined with respect to the main surface of the transparent substrate 123.

Here, a case in which the gate insulating film 133, the passivation film 137, and the semiconductor layer 134 are patterned while the semiconductor layer 134 is formed between the gate insulating film 133 and the passivation film 137 is described.

When the gate insulating film 133, the semiconductor layer 134, and the passivation film 137 are patterned using the planarization film 138 as a mask while the gate insulating film 133, the semiconductor layer 134, and the passivation film 137 are laminated in this order, the edge of the gate insulating film 133 recedes towards the side of the pixel arrangement region 107 compared to the edge of the semiconductor layer 134.

Because of this, in the edge of the multilayer film 109, the semiconductor layer 134 protrudes like eaves. When the ITO films are formed on the edge of the multilayer film 109, it causes the ITO films to fracture.

On the other hand, in Embodiment 1, the peripheral edge of the multilayer film 109 is in a vertically standing shape or a tapered shape with respect to the main surface, and the ITO film formed in the peripheral edge of the multilayer film 109 are less likely to crack and fracture.

Therefore, when etching the ITO films, the etchant can be prevented from reaching the gate lines 111A and 111B.

Here, the distance between the ITO film 141A and the ITO film 142A is set at approximately 10 μm, for example.

Here, in Embodiment 1, an example in which both the gate pads 112A and the gate pads 112B are formed as described above was described. However, the present invention is not limited to this example. For example, the present invention can be applied to an example in which only the plurality of gate pads 112A are formed and to an example in which only the plurality of gate pads 112B are formed.

### Embodiment 2

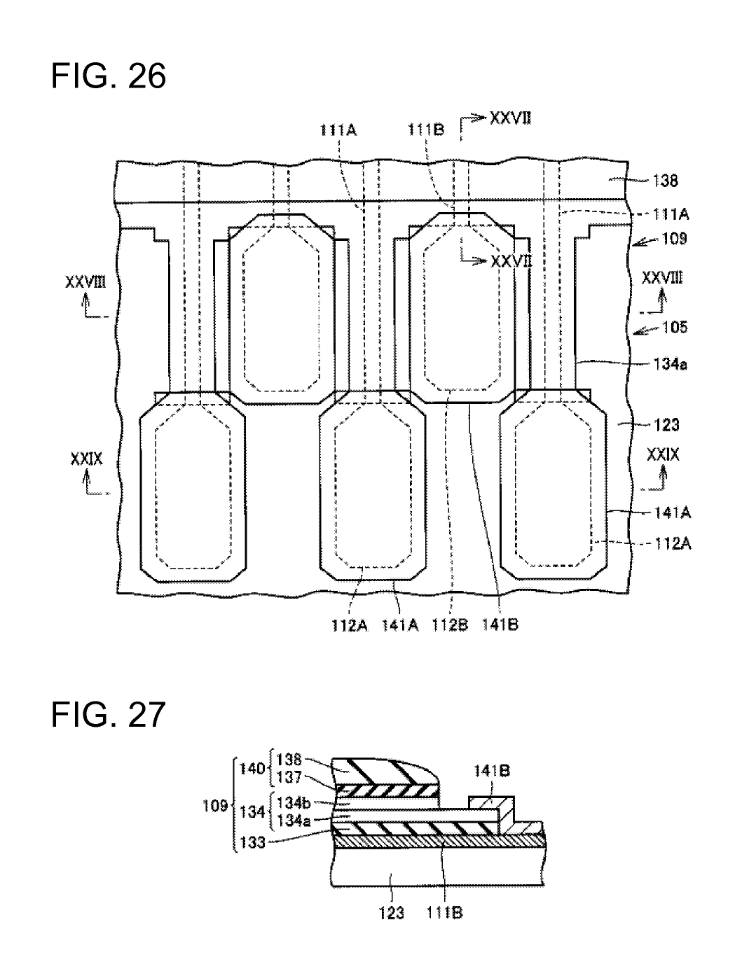

Using FIGS. 26 to 41, a liquid crystal display device 300 according to Embodiment 2 of the present invention is described. Here, of configurations shown in FIGS. 26 to 41, configurations that are the same as or correspond to the configurations shown in FIGS. 1 to 25 are given the same reference characters, and their description may be omitted.

FIG. 26 is a plan view of the peripheral region 105 of the liquid crystal display device of Embodiment 2. FIG. 27 is a cross-sectional view along the line XXVII-XXVII in FIG. 26.

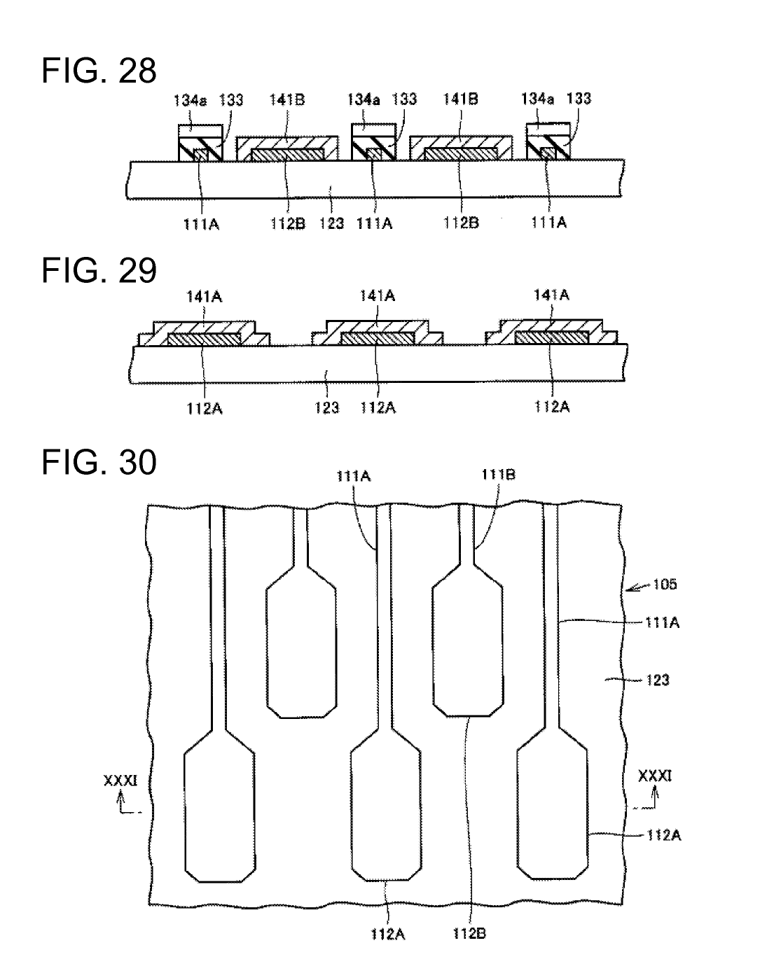

FIG. 28 is a cross-sectional view along the line XXVIII-XXVIII in FIG. 26. FIG. 29 is a cross-sectional view along the line XXIX-XXIX in FIG. 26.

As shown in FIG. 27, in Embodiment 2, the multilayer film 109 includes at least the gate insulating film 133, the semiconductor layer 134, and the interlayer insulating film 140. The amorphous silicon film (i-layer) 134a and the gate insulating film 133 are formed so as to protrude to the peripheral region 105 compared to the interlayer insulating film 140. Here, in Embodiment 2, the respective gate pads 112A and 112B are also exposed from the multilayer film 109.

As shown in FIGS. 26 and 28, the gate lines 111A and 111B are covered by the gate insulating film 133. The ITO films 141A and 141B are formed on the gate pads 112A and 112B.

The gate pads 112B are formed such that there is a slight distance from the gate lines 111A. The gate lines 111A are covered by the gate insulating film 133, thereby preventing a short-circuit between the ITO films 141B formed on the gate pads 112B and the gate lines 111A.

In the peripheral region 105, the amorphous silicon film (i-layer) 134a of the multilayer film 109 is formed on the gate insulating film 133.

As shown in FIG. 27, the upper surfaces and the peripheral surface of the gate pads 112A and 112B exposed from the multilayer film 109 are covered by the ITO films 141A and 141B. The ITO films 141A and 141B are formed so as to reach the upper surface of the amorphous silicon film (i-layer) 134a from the upper surfaces of the gate pads 112A and 112B.

Using FIGS. 30 to 41, a method of manufacturing the liquid crystal display device of Embodiment 2 is described.

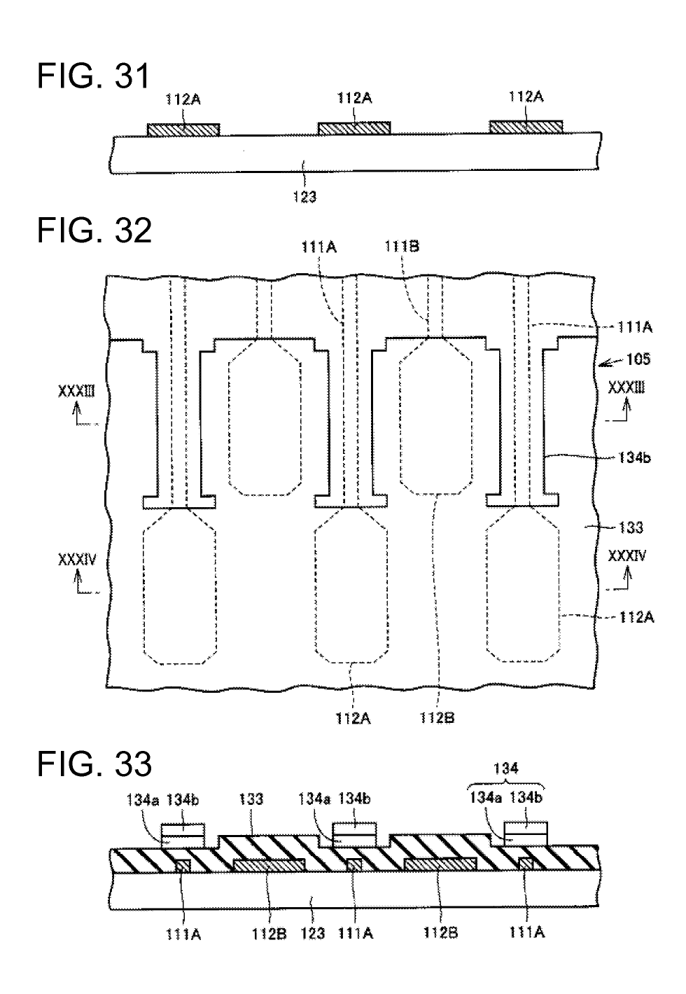

FIG. 30 shows a first process step of the process steps of the liquid crystal display device 300 of Embodiment 2, and is a plan view of the peripheral region 105. FIG. 31 is a cross-sectional view along the line XXXI-XXXI shown in FIG. 30. As shown in FIGS. 30 and 31, first, the transparent substrate 123 having a main surface is prepared. Then, in the same manner as the first process step of the liquid crystal display device 300 of Embodiment 1, an aluminum alloy material film is formed on the main surface of the transparent substrate 123. The aluminum alloy material film is patterned by wet etching to form the gate pads 112A and the like.

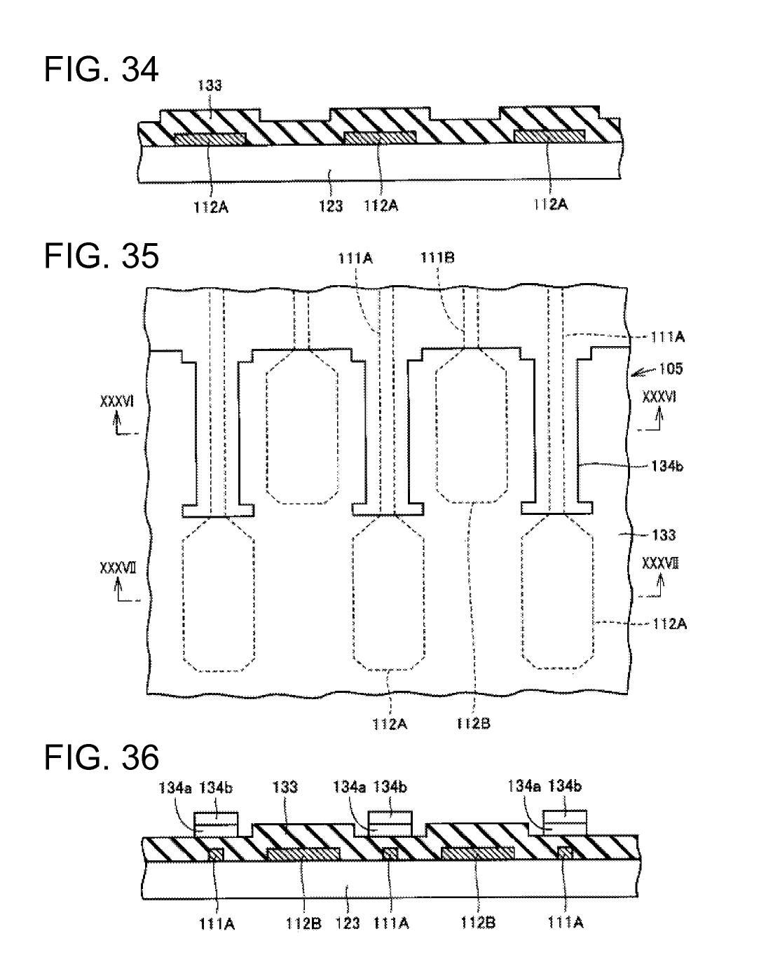

FIG. 32 is a plan view of the peripheral region 105 showing a process step after the process step shown in FIGS. 30 and 31. FIG. 33 is a cross-sectional view along the line XXXIII-XXXIII in FIG. 32. FIG. 34 is a cross-sectional view along the line XXXIV-XXXIV in FIG. 32.

As shown in FIGS. 32 to 34, the gate insulating film 133 is formed on the main surface of the transparent substrate 123 so as to cover the gate lines 111A and 111B and the gate pads 112A and 112B.

Then, the amorphous silicon film (i-layer) 134a and the amorphous silicon film (n+ layer) 134b are laminated in this order. The laminated amorphous silicon film (i-layer) 134a and the amorphous silicon film (n+ layer) 134b are patterned to form the semiconductor layer 134.

Here, as shown in FIGS. 32 and 33, the semiconductor layer 134 is formed over the gate lines 111A and 111B. Here, by performing this patterning, portions of the amorphous silicon film (i-layer) 134a and the amorphous silicon film (n+ layer) 134b that are located over the gate pads 112A and 112B and the portions that are located in the peripheries of these portions are removed.

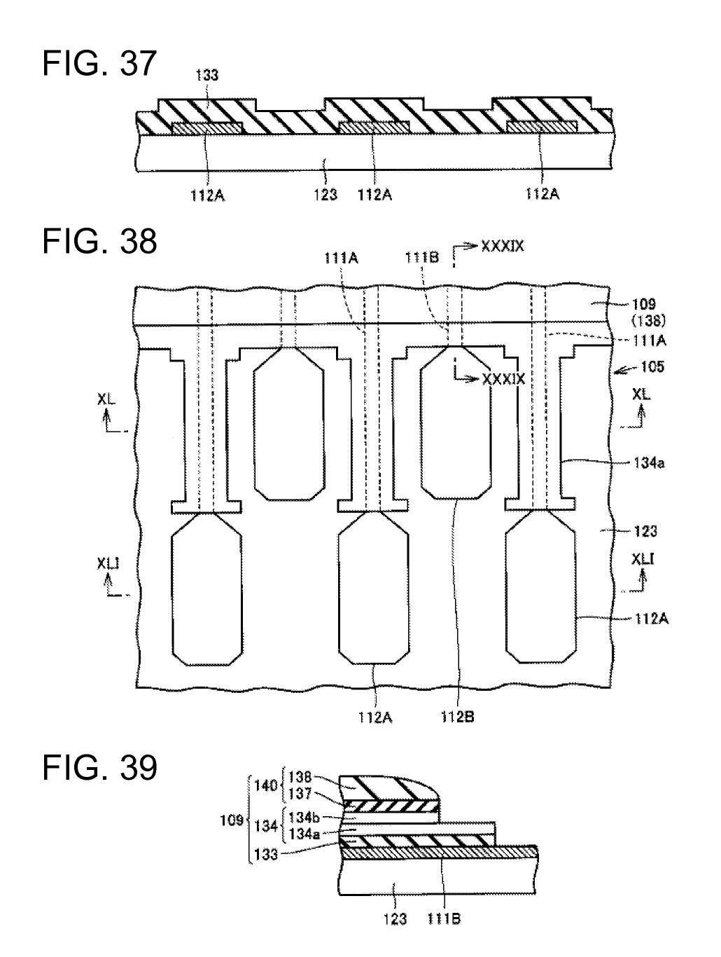

FIG. 35 is a plan view of the peripheral region 105 showing a process step after the process step shown in FIGS. 32 to 34. FIG. 36 is a cross-sectional view along the line XXXVI-XXXVI shown in FIG. 35. FIG. 37 is a cross-sectional view along the line XXXVII-XXXVII shown in FIG. 35.

In FIGS. 35 to 37, the metal films 135a and 136a and the second aluminum alloy material films 135b and 136b are formed in this order as shown in FIG. 19.

Then, the metal films 135a and 136a and the second aluminum alloy material films 135b and 136b are patterned by wet etching to form the source electrode 135 and the drain electrode 136.

By performing the patterning to form the source electrode 135 and the drain electrode 136, the drain pad section 118 and the source line 113 are formed. Portions other than the source electrode 135, the drain electrode 136, the drain pad section 118, and the source line 113 are removed. Thus, in the peripheral region 105 shown in FIG. 35 and its surrounding regions, the metal films 135a and 136a and the second aluminum alloy material film 135b and 136b are not formed.

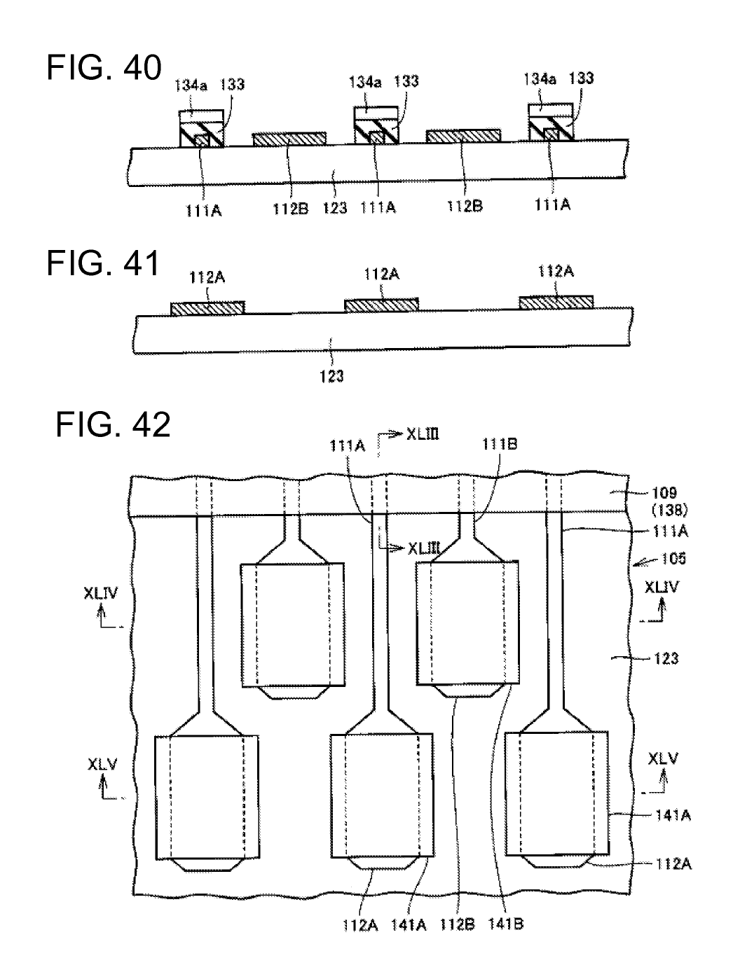

FIG. 38 is a plan view of the peripheral region 105 showing a process step after the process step shown in FIGS. 35 to 37. FIG. 39 is a cross-sectional view along the line XXXIX-XXXIX in FIG. 38. FIG. 40 is a cross-sectional view along the line XL-XL in FIG. 38. FIG. 41 is a cross-sectional view along the line XLI-XLI in FIG. 38.

In FIGS. 38 to 41, the amorphous silicon film (n+ layer) 134b located between the source electrode 135 and the drain electrode 136 is removed, and the amorphous silicon film (n+ layer) 134b located on the peripheral region 105 is removed as well. This way, in the peripheral region 105, the amorphous silicon film (i-layer) 134a is exposed.

Then, the passivation film 137 and the planarization film 138 are laminated in this order. Then, the planarization film 138 is patterned. By patterning the planarization film 138, portions located in the peripheral region 105 are removed. Using the patterned planarization film 138 as a mask, the passivation film 137 and the gate insulating film 133 are patterned.

This way, the gate insulating film 133 located below the amorphous silicon film (i-layer) 134a is left, and this remaining gate insulating film 133 covers the upper surfaces and the peripheral surface of the gate lines 111A.

On the other hand, on the gate pads 112A and 112B, the amorphous silicon film (i-layer) 134a is not formed. Therefore, the gate pads 112A, 112B and the main surface of the transparent substrate 123 located in their peripheries are exposed.

After this process step, an ITO film is formed on the gate pads 112A and 112B, the main surface of the transparent substrate 123, the amorphous silicon film (i-layer) 134a, and the planarization film 138.

As shown in FIG. 26, this formed ITO film is patterned to form the ITO films (ITO films for pads) 141A and 141B on the gate pads 112A and 112B.

Here, when patterning the ITO film to form the ITO films for pads, the gate lines 111A and 111B are covered by the amorphous silicon film (i-layer) 134a and the gate insulating film 133. Therefore, disconnection of the gate lines 111A and 111B can be suppressed.

Furthermore, also in Embodiment 2, the ITO films 141A and 141B are left so as to cover the gate pads 112A and 112B. Therefore, when patterning the ITO films, the gate pads 112A and 112B can be prevented from being patterned.

### Embodiment 3

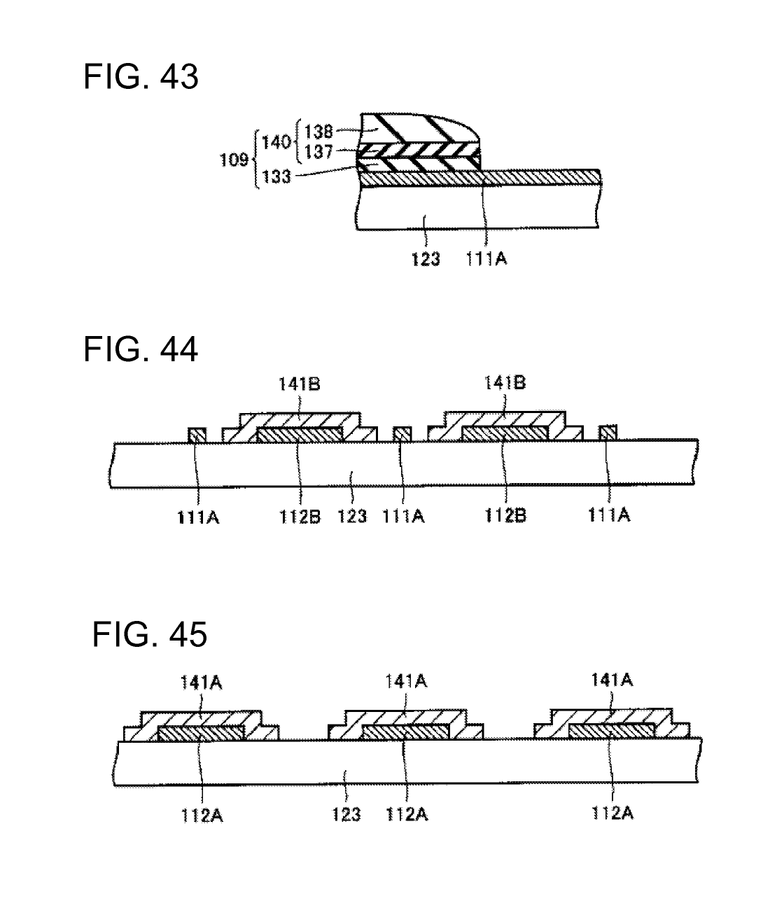

Using FIGS. 42 to 54, a liquid crystal display device 300 according to Embodiment 3 is described. Here, of the configurations shown in FIGS. 42 to 54, configurations that are the same as or correspond to the configurations shown in FIGS. 1 to 41 above are given the same reference characters, and their description is omitted. FIG. 42 is a plan view of the peripheral region 105 of the liquid crystal display device 300 of Embodiment 3. FIG. 43 is a cross-sectional view along the line XLIII-XLIII in FIG. 42. FIG. 44 is a cross-sectional view along the line XLIV-XLIV in FIG. 42. FIG. 45 is a cross-sectional view along the line XLV-XLV in FIG. 42.

As shown in FIG. 42 and the like, the gate pads 112A and 112B and the gate lines 111A and 111B that are located in the peripheral region 105 are exposed from the multilayer film 109. The ITO films 141A and 141B are formed on the upper surfaces and the peripheral surfaces of the gate pads 112A and 112B, whereas they are not formed on the gate lines 111A and 111B. The gate lines 111A and 111B are also exposed from the ITO films 141A and 141B.

Here, the gate pads 112A are disposed so as to be farther away from the multilayer film 109 than the gate pads 112B. Furthermore, on the gate lines 111A that are adjacent to the gate pads 112B, the ITO films are not formed.

Because of this, distances between the ITO films 141B and the ITO films 141A are secured, thereby preventing short-circuits between the ITO films 141A and the ITO films 141B.

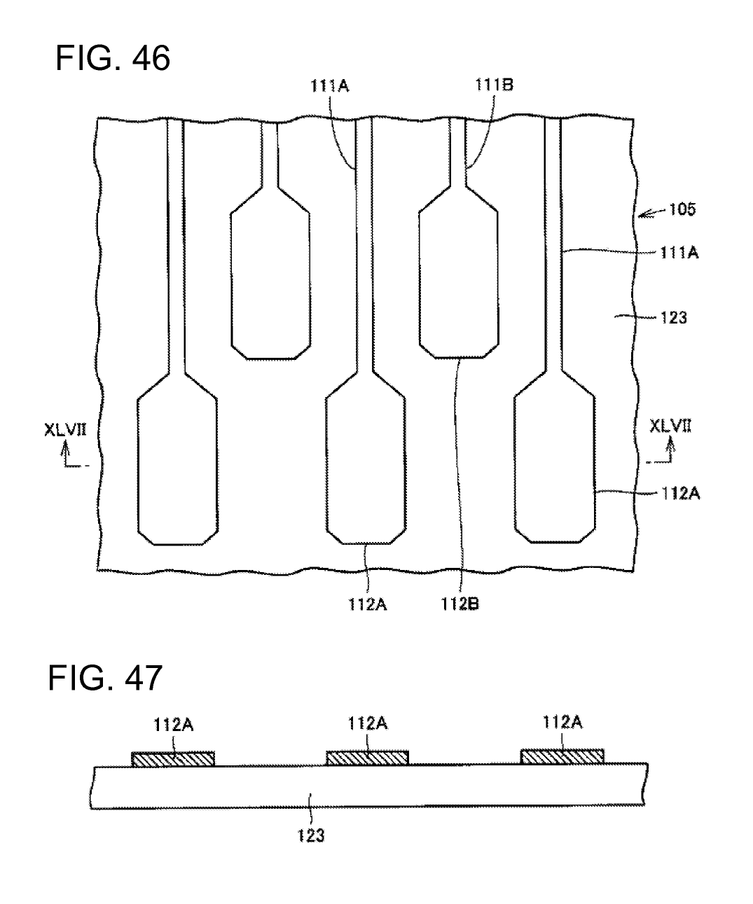

Using FIGS. 46 to 54, a method of manufacturing the liquid crystal display device of Embodiment 3 is described.

FIG. 46 is a plan view of the peripheral region 105 showing a step of forming the gate lines 111A and 111B and the gate pads 112A and 112B. FIG. 47 is a cross-sectional view along the line XLVII-XLVII in FIG. 46. As shown in FIGS. 46 and 47, on the main surface of the transparent substrate 123, an aluminum alloy material film is formed. This aluminum alloy film is patterned to form the gate lines 111A and 111B and the gate pads 112A and 112B.

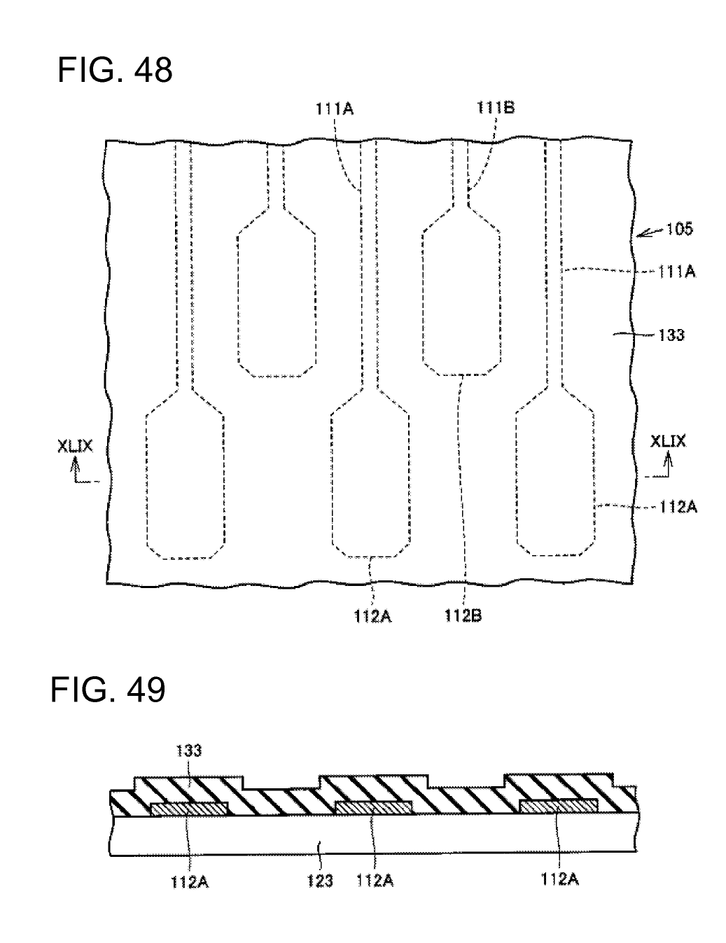

FIG. 48 is a plan view of the peripheral region 105 showing a process step after the process step shown in FIGS. 46 and 47. FIG. 49 is a cross-sectional view along the line XLIX-XLIX in FIG. 48.

In FIGS. 48 and 49, the gate insulating film 133 is formed. Then, the semiconductor later 134 is formed. The semiconductor layer 134 is not formed in the peripheral region 105, and is removed during patterning.

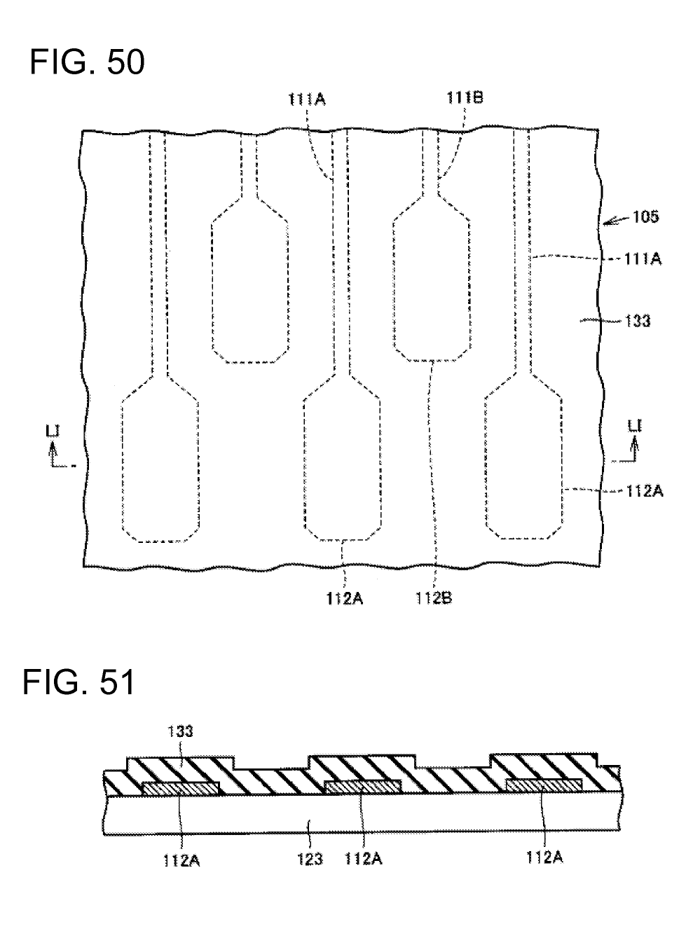

FIG. 50 is a plan view of the peripheral region 105 showing a process step after the process step shown in FIGS. 48 and 49. FIG. 51 is a cross-sectional view along the line LI-LI in FIG. 50.

FIGS. 50 and 51 show a step of forming the source electrode 135 and the drain electrode 136. The metal films 135a and 136a and the second aluminum alloy material films 136a and 136b are removed from the peripheral region 105 during patterning.

Thus, after the source electrode 135 and the drain electrode 136 have been formed, the metal films 135a and 136a and the second aluminum alloy material films 136a and 136b are not left on the peripheral region 105.

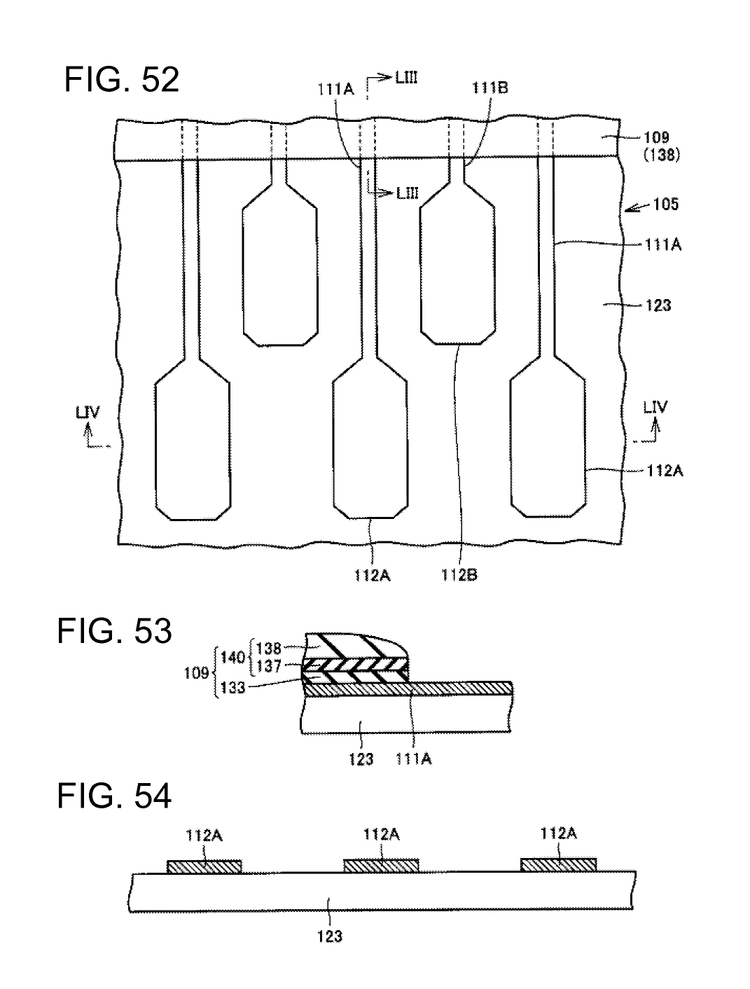

FIG. 52 is a plan view showing the peripheral region 105 showing a process step after the process step shown in FIGS. 50 and 51. FIG. 53 is a cross-sectional view along the line LIII-LIII in FIG. 52. FIG. 54 is a cross-sectional view along the line LIV-LIV in FIG. 52.

In FIGS. 52 to 54, after the planarization film 138 has been formed, the planarization film 138 is patterned. Using the patterned planarization film 138 as a mask, the passivation film 137 and the gate insulating film 133 are patterned.

This way, the gate lines 111A and 111B and the gate pads 112A and 112B are exposed in the peripheral region 105.

Then, in Embodiment 3, an amorphous-ITO (Indium Tin Oxide) is formed on the main surface of the transparent substrate 123 and on the multilayer film 109 so as to cover the gate lines 111A and 111B and the gate pads 112A and 112B.

Then, this amorphous-ITO film is patterned using an oxalic acid. The oxalic acid etches the amorphous-ITO film. On the other hand, the aluminum alloy material films are hardly etched by the oxalic acid.

Therefore, even if the gate lines 111A and 111B are exposed from the ITO films 141A and 141B as shown in FIG. 42, adverse effects such as disconnection and the like can be prevented from occurring.

Alternatively, instead of the amorphous-ITO film, an IZO (amorphous indium zinc oxide) or the like may be used.

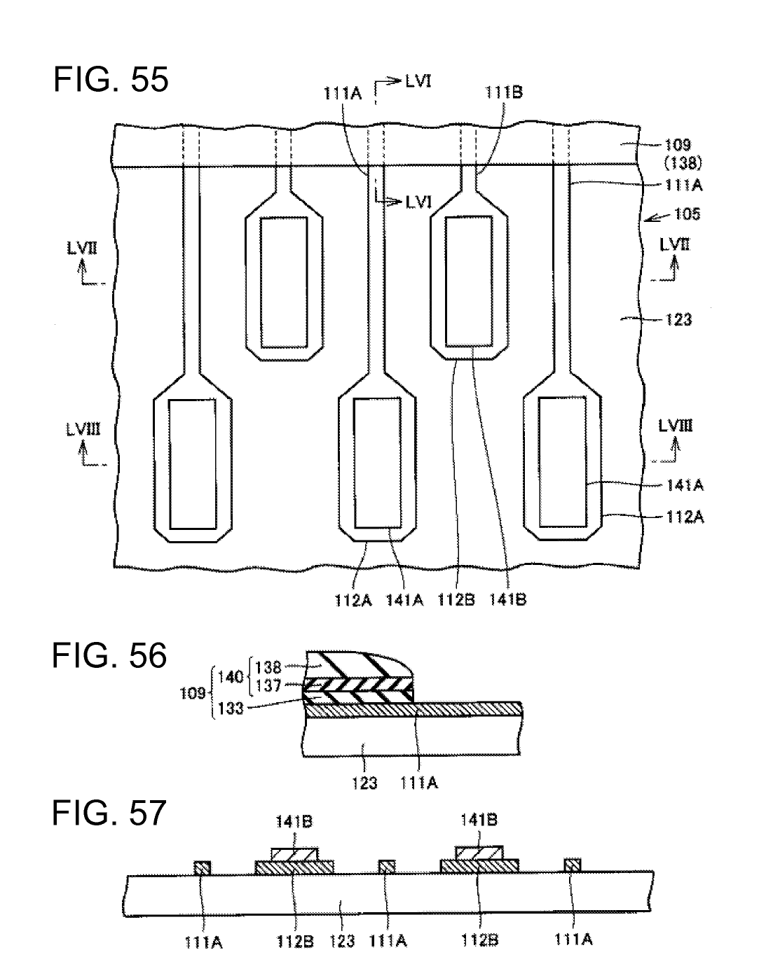

Thus, as shown in FIGS. 55 to 58, the ITO films 141A and 141B can be formed so as to be formed only on the upper surfaces of the gate pads 112A and 112B.

As described above, by leaving the ITO films only on the upper surfaces of the gate pads 112A and 112B, the distance between the respective ITO films 141A and 141B can be secured, thereby suppressing short-circuits between the ITO films 141A and 141B.

### Embodiment 4

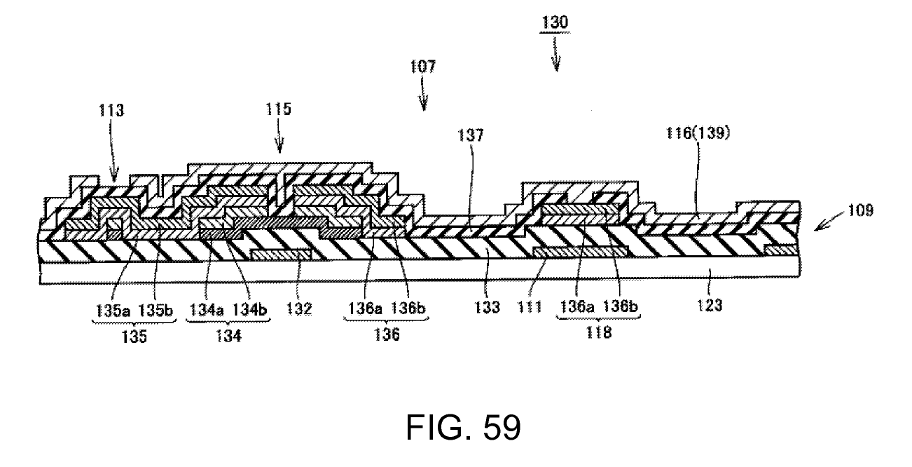

Using FIGS. 59 to 69, a liquid crystal display device 300 according to Embodiment 4 of the present invention is described.

Here, of the configurations shown in FIGS. 59 to 69, configurations that are the same as or correspond to the configurations shown in FIGS. 1 to 58 above are given the same reference characters, and their description may be omitted.

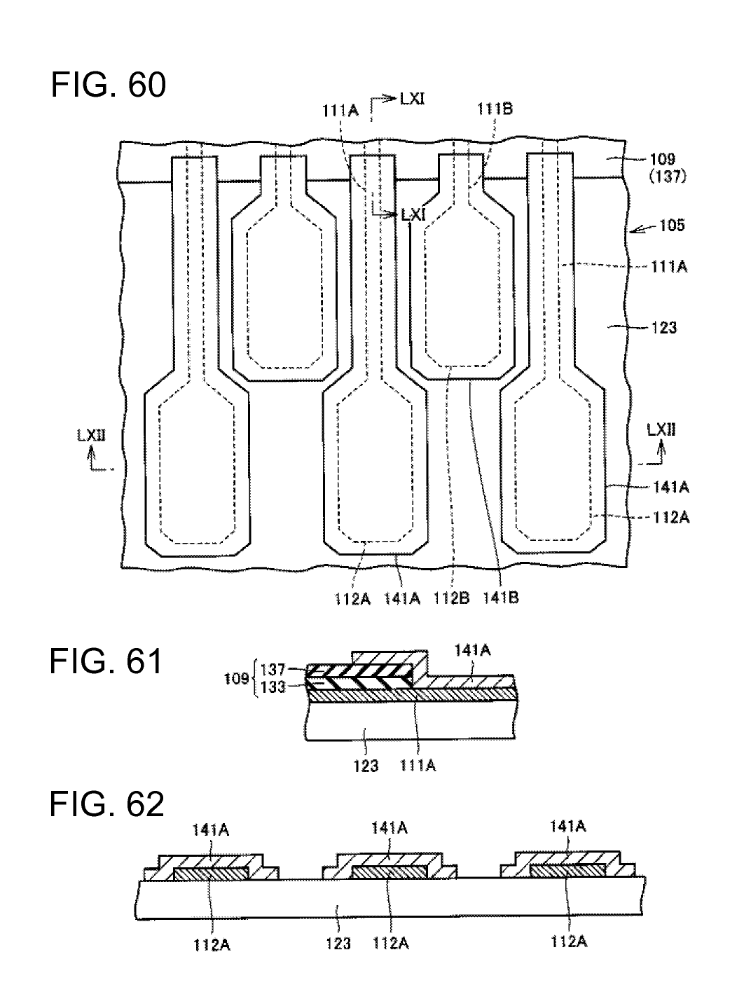

FIG. 59 is a cross-sectional view of the liquid crystal display device 300 of Embodiment 4 of the present invention. FIG. 60 is a plan view of the peripheral region 105 of the liquid crystal display device 300 shown in FIG. 59.

Here, as shown in FIG. 59, in the liquid crystal display device 300 of Embodiment 4, the pixel electrode 116 is formed on the upper surface of the passivation film 137. Thus, in the liquid crystal display device 300 of Embodiment 4, there is no planarization film formed in the pixel arrangement region 107. Therefore, in Embodiment 4, the multilayer film 109 formed in the pixel arrangement region 107 is formed of the gate insulating film 133, the semiconductor layer 134, the drain electrode 136, the source electrode 135, and the passivation film 137.

Further, as shown in FIG. 60, in the peripheral region 105, the multilayer film 109 is not formed. The main surface of the transparent substrate 123 located in the peripheries of the gate pads 112 (112A, 112B) and the ITO films 141 (141A, 141B) is exposed from the multilayer film 109.

Further, in the liquid crystal display device 300 of Embodiment 4, in a manner similar to that of the liquid crystal display device 300 of Embodiment 1, the ITO films 141 are also formed so as to cover portions of the gate lines 111 that are exposed from the multilayer film 109 and the gate lines 111.

FIG. 61 is a cross-sectional view along the line LXI-LXI in FIG. 60. As shown in FIG. 61, the ITO film 141A is formed so as to run from the upper surface of the gate line 111A through the peripheral surfaces of the gate insulating film 133 and the passivation film 137 to reach the upper surface of the passivation film 137.

FIG. 62 is a cross-sectional view along the line LXII-LXII in FIG. 60. As shown in FIG. 62, in a manner similar to that of the liquid crystal display device 300 of Embodiment 1, the liquid crystal display device 300 of Embodiment 4 is formed so as to run from the main surface of the transparent substrate 123 located in the peripheries of the gate pads 112 (112A, 112B) through the peripheral surfaces of the gate pads 112 to reach the upper surface of the gate pads 112.

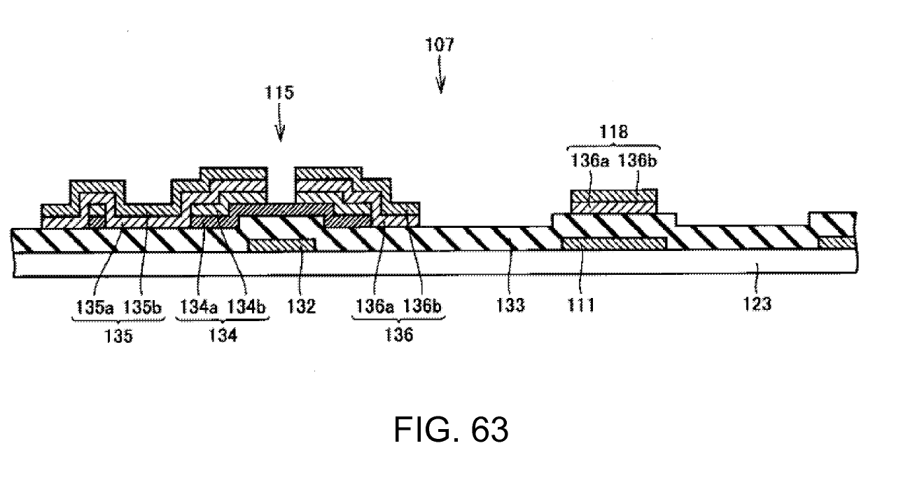

A method of manufacturing the liquid crystal display device 300 configured as described above is described using FIGS. 63 to 69.

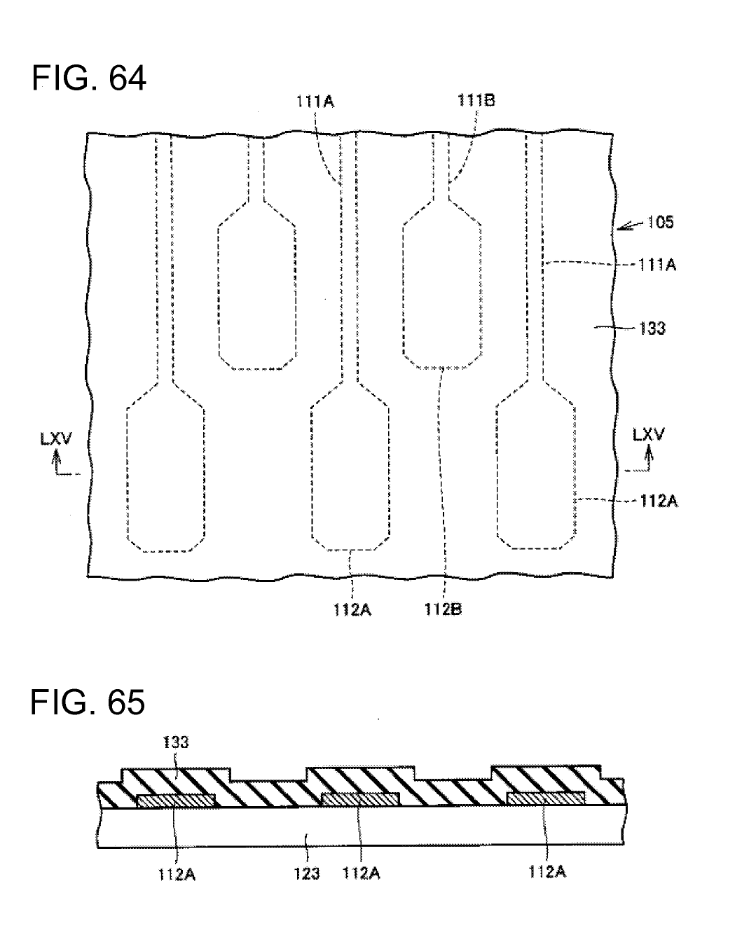

FIG. 63 is a cross-sectional view of a process step of the liquid crystal display device 300 of Embodiment 4 when the source electrode 135, the drain electrode 136, and the drain pad section 118 are formed. FIG. 64 is a plan view of the peripheral region 105 during the process step shown in FIG. 63. FIG. 65 is a cross-sectional view along the line LXV-LXV shown in FIG. 64.

As shown in FIGS. 64 and 65, during this process step, the gate insulating film 133 is formed so as to cover the gate pads 112A and 112B.

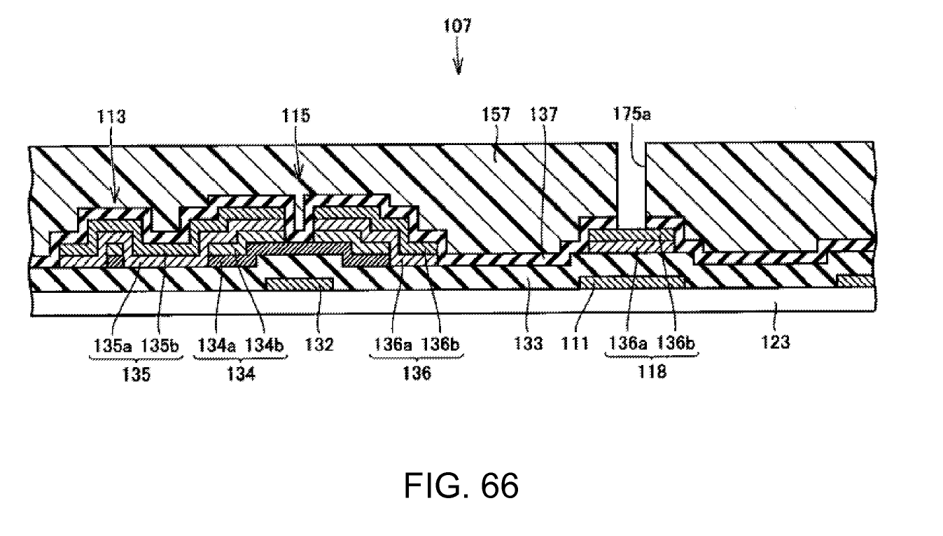

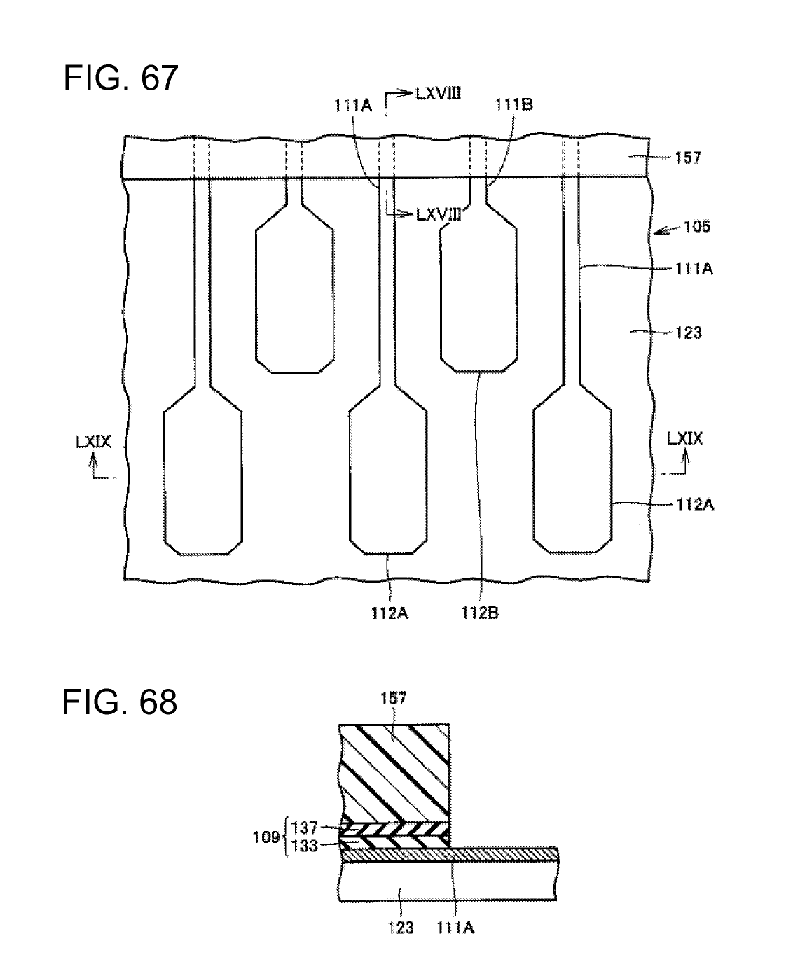

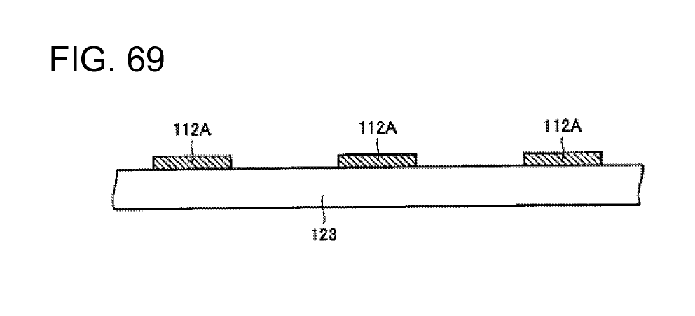

FIG. 66 is a cross-sectional view showing a process step after the process step shown in FIGS. 63 to 65. FIG. 67 is a plan view of the peripheral region 105 during the process step shown in FIG. 66. Further, FIG. 68 is a cross-sectional view along the line LXVIII-LXVIII in FIG. 67, and FIG. 69 is a cross-sectional view along the line LXIX-LXIX in FIG. 67.

As shown in FIGS. 66 to 69, the passivation film 137 is formed so as to cover the source electrode 135, the drain electrode 136, the gate lines 111, and the gate pads 112.

Then, a resist film 157 is formed on the passivation film 137. The resist film 157 is patterned to form a hole 175a located above the drain pad section 118, and a portion of the resist film 157 located in the peripheral region 105 is removed.

Then, using the patterned resist film 157, the passivation film 137 and the gate insulating film 133 are patterned.

This way, a portion of the upper surface of the drain electrode 136 becomes exposed. Furthermore, in the peripheral region 105, portions of the gate lines 111 become exposed, and the gate pads 112 become exposed. Then, the resist film 157 is removed.

As described, the upper surface of the drain electrode 136, portions of the gate lines 111, and the gate pads 112 are exposed. Then, using an alkali solution, a surface treatment is performed on the upper surface of the drain electrode 136, the upper surfaces of exposed gate lines 111, and the surfaces of the gate pads 112.

This way, deposits are exposed from the surface of the second aluminum alloy material film 136b, and deposits are exposed from the surfaces of the gate lines 111 and the gate pads 112.

As described above, after the surface treatment has been performed, an ITO film is formed as shown in FIGS. 59, 60, and the like. The formed ITO film is patterned to form the pixel electrode 116 connected to the second aluminum alloy material film 136b and the ITO films 141A and 141B formed on the gate pads 112A and 112B and the gate lines 111A and 111B.

The liquid crystal display device 300 of Embodiment 4 can be manufactured as described. Here, in Embodiments 1 to 4 above, liquid crystal display devices 300 having the thin film transistors 115 that include an amorphous silicon film were described. However, the present invention is not limited thereto. For example, the present invention can be applied to a liquid crystal display device 300 using low temperature polysilicon TFTs, which use low temperature polysilicon (p-Si), for example. Alternatively, instead of the thin film transistors 115, an oxide semiconductor may be used.

### Example 1

Table 1 below is a table showing the results of an evaluation of resistance to a developing solution when an aluminum alloy material film in which the wt % of the alloy component containing at least one type of element selected from a group constituted of Co, Rh, Ni, Pd, C, Si, Ge, and Sn was changed and an ITO film were laminated (the aluminum alloy material film on the ITO film). Here, in Table 1 below, “B” means that there was corrosion, and “A” means that there was no corrosion.

Further, Table 2 below shows a graph of an evaluation of the contact resistance when the aluminum alloy material film and the ITO film were laminated. Here, in Table 2 below, “A” means that the contact resistance was 100Ω or less. Here, the contact resistance between pure aluminum and the ITO film is 100Ω.

TABLE 1
<In a case of an Al alloy/ITO configuration>
Evaluation of resistance to a developing solution

| | wt % of the alloy component | | | | | |
|---|---|---|---|---|---|---|
| | 0.2 wt % | 0.5 wt % | 0.7 wt % | 1.0 wt % | 3.2 wt % | 4.5 wt % |
| Findings | B | A | A | A | A | A |

B: Corrosion occurred.
A: No corrosion occurred.

TABLE 2
<In a case of an ITO/Al alloy configuration>
Evaluation of contact resistance

| | Total components of the group above | | | | | |
|---|---|---|---|---|---|---|
| | (Co, Rh, Ni, Pd, C, Si, Ge, and Sn) | | | | | |
| | 0.2 wt % | 0.5 wt % | 0.7 wt % | 1.0 wt % | 3.2 wt % | 4.5 wt % |
| Findings | A | A | A | A | A | A |

B: 100 Ω or more (pure Al)
A: 100 Ω or less

As shown in Table 1 above, when the alloy component containing at least one type of element selected from a group constituted of Co, Rh, Ni, Pd, C, Si, Ge, and Sn is 0.5 wt % or more, it can be said that the resistance to the developing solution is secured. Furthermore, by using an aluminum alloy material film in which the alloy component containing at least one type of element selected from a group constituted of Co, Rh, Ni, Pd, C, Si, Ge, and Sn is 0.5 wt % or more and 4.5 wt % or less, it can be said that the resistance to the developing solution can be secured.

Furthermore, as shown in Table 2 above, by using an aluminum alloy film in which the alloy component containing at least one type of element selected from a group constituted of Co, Rh, Ni, Pd, Si, Ge, and Sn is 0.2 wt % or more, it can be said the contact resistance can be suppressed at a lower level compared to a case in which pure aluminum is used.

Furthermore, by using an aluminum alloy material film in which the alloy component containing at least one type of element selected from a group constituted of at least Co, Rh, Ni, Pd, C, Si, Ge, and Sn is 0.2 wt % or more and 4.5 wt % or less, the contact resistance can be suppressed at a lower level compared to when pure aluminum is used.

This way, as shown in Table 1 and Table 2, by using an aluminum alloy material film in which the alloy component containing at least one type of element selected from a group constituted of Co, Rh, Ni, Pd, C, Si, Ge, and Sn is 0.5 wt % or more and 4.5 wt % or less, it can be said that resistance to the developing solution and reduction of the contact resistance can be achieved.

### Example 2

Table 3 below is a table showing components of the second aluminum alloy material film 135b. Table 4 below shows results determining whether Ni of the second aluminum alloy material film 135b has diffused to the semiconductor layer 134 located below the metal film 135a when the metal film 135a is formed on the lower surface of the second aluminum alloy material film 135b shown in Table 3. Specifically, this is a table showing results determining whether or not Ni of the second aluminum alloy material film 135b has diffused to the semiconductor layer 134 when the metal film 135a is formed of titanium (Ti) and when the metal films 135a is formed of molybdenum (Mo).

TABLE 3

Components contained in Al alloy
(second aluminum alloy material film 135b)

| Metal | Al | Ni | Cu | La |
|---|---|---|---|---|
| Density | 2.7 | 8.9 | 8.89 | 6.15 |
| Findings | — | — | — | — |

TABLE 4

Base film (metal film 135a)

| Metal | Ti | Mo |
|---|---|---|
| Density | 4.54 | 10.2 |
| Findings | B | A |

B: Diffusion to the semiconductor layer occurred
A: No diffusion to the semiconductor layer

In Table 4 above, “B” shows that diffusion of “Ni” inside the second aluminum alloy material film 135b to the inside of the semiconductor layer 134 was confirmed. Furthermore, in Table 4 above, “A” shows that diffusion of “Ni” inside the second aluminum alloy material film 135b to the inside of the semiconductor layer 134 was not confirmed.

Here, whether or not the “Ni” has diffused inside the semiconductor layer 134 was analyzed using ToF-SIMS (Time-of-flight secondary ion mass spectrometry).

As a result, when the metal film 135a was formed of titanium, it was possible to confirm diffusion of “Ni”. On the other hand, when the metal film 135a was formed of molybdenum, it was not possible to confirm diffusion of “Ni”. Thus, it can be said that by forming the metal film 135a of molybdenum, “Ni” can be prevented from diffusing, thereby securing the performance of the thin film transistors.

Furthermore, as shown in Table 3 and Table 4 above, the density of titanium (Ti) is 4.54, which is lower than the densities of elements Ni, Cu, and La that constitute a portion of the second aluminum alloy material film 135b. On the other hand, molybdenum (Mo) has a higher density than any other elements constituting the second aluminum alloy material film 135b.

As described, as the result of diligent efforts, the inventors have found that elements inside the second aluminum alloy material film 135b can be prevented from diffusing to the semiconductor layer 134 by using an element having a higher density than the elements constituting the second aluminum alloy material film 135b.

### Example 3

Using a secondary ion mass spectrometry (SIMS), the inventors have compared a case in which an aluminum alloy material film was formed on a titanium (Ti) film and a case in which the above-mentioned aluminum alloy material film was formed on a Mo film. As a result, due to the inventors' diligent efforts, it was found that Ni diffused inside the titanium (Ti) film at a rate of 40% of the amount contained inside the aluminum alloy material film. On the other hand, in the example in which the aluminum alloy material film was formed on the molybdenum (Mo) film, it was found that Ni diffused in the molybdenum film at a rate of 1.0% or less of the amount contained inside the aluminum alloy material film.

As described, as a result of diligent efforts of the inventors, it was found that Ni inside the aluminum alloy material film hardly diffused when molybdenum was used. As described, it can be said that Ni can be prevented from diffusing by disposing a metal film formed of molybdenum (Mo) between the aluminum alloy material film and the semiconductor film.

As described above, embodiments and examples of the present invention were described. However, it should be considered that the embodiments and examples disclosed here are examples in every aspect and that they are not restrictive. The scope of the present invention is shown by claims, and all modifications that are equivalent to claims or within the scope are intended to be included. Furthermore, above-mentioned numerical values are mere examples, and the present invention is not limited to the above-mentioned numerical values and ranges.

### INDUSTRIAL APPLICABILITY

The present invention can be applied to a liquid crystal display device and a method of manufacturing a liquid crystal display device.

### DESCRIPTION OF REFERENCE CHARACTERS

101 liquid crystal display panel, 103 display region, 104 non-display region, 105 peripheral region, 107 pixel arrangement region, 109 multilayer film, 111 gate lines, 112 gate pads, 113 source wires, 115 thin film transistors, 116 pixel electrode, 118 drain pad section, 119a deposits, 119b base material, 123 transparent substrate, 130 active matrix substrate, 132 gate electrode, 133 gate insulating film, 134 semiconductor layer, 135b, 136b aluminum alloy material films, 135 source electrode, 135a, 136a metal films, 136 drain electrode, 137 passivation film, 138 planarization film, 140 interlayer insulating film, 150 gate terminal section, 151 source terminal section, 152 gate drivers, 153 source drivers, 154 printed substrate wiring, 155 display control circuit, 175 contact hole, 183 opening, 184 operation circuit, 185 support member, 186 backlight unit, 200 liquid crystal display element, 300 liquid crystal display device, 500 television receiver.

1. A liquid crystal display device, comprising:
a substrate having a pixel arrangement region and a peripheral region that is located in a periphery of said pixel arrangement region;
a switching element formed in said pixel arrangement region;
an electrode provided in said switching element;
a lead-out wire connected to said switching element;
a pad section connected to said lead-out wire;
a transparent conductive film formed on the respective pad section; and
a multilayer film that is formed in said pixel arrangement region and that is formed of a plurality of laminated films,
wherein said pad sections and a main surface of said substrate located in the periphery of said pad sections are formed so as to be exposed from said multilayer film, and said pad section are formed of an aluminum alloy material film, and
wherein a difference between a potential of said aluminum alloy material film and that of said transparent conductive film is smaller than a difference between a potential of an aluminum film and that of said transparent conductive film.

2. The liquid crystal display device according to claim 1, wherein said transparent conductive film is formed to reach a peripheral surface of and an upper surface of said pad section from a main surface of said substrate that is located in the periphery of said pad section.

3. The liquid crystal display device according to claim 1, wherein said multilayer film is formed in said pixel arrangement region, and is formed so as to expose said lead-out wire located in said peripheral region.

4. The liquid crystal display device according to claim 3, wherein said transparent conductive film is formed on a portion of said lead-out wire that is exposed from said multilayer film.

5. The liquid crystal display device according to claim 1, wherein said transparent conductive film is formed only on the upper surface of said pad section.

6. The liquid crystal display device according to claim 1, wherein conductive deposits are formed in said aluminum alloy material film, and
wherein said deposits are formed so as to be exposed from the upper surface and the peripheral surface of said pad section.

7. The liquid crystal display device according to claim 1, wherein said lead-out wire is formed of said aluminum alloy material film,
wherein a portion of said lead-out wire located in said peripheral region is formed so as to be exposed from said multilayer film,
wherein conductive deposits are formed in said aluminum alloy material film forming said pad section and said lead-out wire,
wherein said deposits are formed so as to be exposed from a portion of the surface of said lead-out wire exposed from said multilayer film and a surface of said pad section, and
wherein said transparent conductive film is formed on portions of said lead-out wire exposed from said multilayer film and on said pad section.

8. The liquid crystal display device according to claim 1, wherein a plurality of said switching elements are formed in said pixel arrangement region,
wherein said switching elements include a first switching element and a second switching element,
wherein said lead-out wire includes a first lead-out wire connected to said first switching element and a second lead-out wire connected to said second switching element,
wherein said pad section includes a first pad section connected to said first lead-out wire and a second pad section connected to said second lead-out wire, and
wherein said first pad section is formed so as to be farther away from said pixel arrangement region than said second pad section.

9. The liquid crystal display device according to claim 1, wherein a plurality of said switching elements are formed in said pixel arrangement region,
wherein said switching elements include a first switching element and a second switching element,
wherein said lead-out wire includes a first lead-out wire connected to said first switching element and a second lead-out wire connected to said second switching element,
wherein said pad section includes a first pad section connected to said first lead-out wire and a second pad section connected to said second lead-out wire, and
wherein said first pad section is formed so as to be farther away from said pixel arrangement region than said second pad section, and said first lead-out wire is covered by an insulating film.

10. The liquid crystal display device according to claim 1, further comprising a gate insulating film formed on the main surface of said substrate so as to cover a gate electrode, a semiconductor layer formed on said gate insulating film, a source electrode and a drain electrode formed on said semiconductor layer, and an interlayer insulating film formed so as to cover said source electrode and said drain electrode,
wherein said multilayer film includes at least said interlayer insulating film.

11. The liquid crystal display device according to claim 1, wherein said aluminum alloy material film contains aluminum as a base material, an alloy component containing at least one type of element selected from a group constituted of cobalt, rhodium, nickel, palladium, carbon, silicon, germanium, and tin, and another component containing an element that is different from aluminum and said elements listed, the sum of elements in said alloy component and elements in said another component being three types or more.

12. The liquid crystal display device according to claim 1, wherein said aluminum alloy material film has aluminum as a base material, an alloy component containing at least one type of element selected from a group constituted of cobalt (Co), rhodium (Rh), nickel (Ni), palladium (Pd), carbon (C), silicon (Si), germanium (Ge), and tin (Sn), and another component containing at least one type of element selected from a group constituted of copper (Cu), lanthanum (La), boron (B), neodymium (Nd), silver (Ag), gold (Au), platinum (Pt), yttrium (Y), niobium (Nb), tungsten (W), and zirconium (Zr).

13. The liquid crystal display device according to claim 11, wherein said aluminum alloy material film contains 0.5 wt % or more of said alloy component.

14. The liquid crystal display device according to claim 13, wherein said alloy component contained in said aluminum alloy material film is 4.5 wt % or less.

15. The liquid crystal display device according to claim 1, wherein said switching element includes a gate electrode formed on the main surface of said substrate, a semiconductor layer formed on said gate electrode, a source electrode formed on said semiconductor layer, and a drain electrode that is formed on said semiconductor layer and that is formed so as to have a distance from said source electrode,
wherein said lead-out wire includes a gate line connected to said gate electrode and a source line connected to said source electrode,
wherein said pad section includes a gate pad connected to said gate line and a source pad connected to said source line, and
wherein said gate electrode, said gate line, and said gate pad are formed of said aluminum alloy material film.

16. The liquid crystal display device according to claim 15, wherein said source electrode and said drain electrode include said aluminum alloy material film.

17. A method of manufacturing a liquid crystal display device, the method comprising:
preparing a substrate having a main surface;
forming an aluminum alloy material film on the main surface of said substrate;
patterning said aluminum alloy material film to form a pad section;
forming a multilayer film so as to expose said pad section and the main surface of said substrate located in a periphery of said pad section, the multilayer film including a plurality of laminated films; and
forming a transparent conductive film for pad sections on said pad section,
wherein a difference between a potential of said aluminum alloy material film and that of transparent conductive films for pad sections is smaller than a difference between a potential of an aluminum film and that of said transparent conductive films for pad sections.

18. The method of manufacturing a liquid crystal display device according to claim 17, wherein forming said transparent conductive films for pad sections on the pad section includes forming a transparent conductive film on said pad section exposed from said multilayer film and patterning said transparent conductive film such that said transparent conductive film remains on an upper surface and a peripheral surface of said pad section.

19. The method of manufacturing a liquid crystal display device according to claim 17, wherein forming said transparent conductive film for pad sections on the pad section includes forming a transparent conductive film on the main surface of said substrate and on said pad section that are exposed from said multilayer film and patterning said transparent conductive film such that said transparent conductive film reaches a peripheral surface and an upper surface of said pad section from the main surface of said substrate located in the periphery of said pad sections.

20. The method of manufacturing a liquid crystal display device according to claim 17, wherein said aluminum alloy material film is patterned to form said pad section, a gate electrode located on the main surface of said substrate, and a lead-out wire connecting said pad section to said gate electrode,
wherein forming said multilayer film includes forming a gate insulating film that covers said gate electrode and said lead-out wire, and
wherein forming said transparent conductive film for pad sections on the pad section includes patterning a transparent conductive film such that said transparent conductive film for pad sections remains on said pad section that are exposed from said gate insulating film.

21. The method of manufacturing a liquid crystal display device according to claim 17, further comprising:
forming a conductive deposit in said aluminum alloy material film; and
exposing said deposit from a surface of said pad section.

22. The method of manufacturing a liquid crystal display device according to claim 21, wherein said aluminum alloy material film is patterned to form said pad section, a gate electrode located on the main surface of said substrate, and a lead-out wire connecting said pad section to said gate electrode,
wherein forming said multilayer film includes forming a gate insulating film that covers said pad section, said gate electrode, and said lead-out wire, and
wherein said deposit is formed by heat generated when said gate insulating film is formed.
